(19) United States
(12) Patent Application Publication
(10) Pub. No.: US 2024/0385296 A1
(43) Pub. Date: Nov. 21, 2024

(54) OBJECT DETECTION APPARATUS AND OBJECT DETECTION METHOD

(71) Applicant: DENSO CORPORATION, Kariya-city (JP)

(72) Inventor: KEIKO AKIYAMA, Kariya-city (JP)

(21) Appl. No.: 18/787,139

(22) Filed: Jul. 29, 2024

Related U.S. Application Data
(63) Continuation of application No. PCT/JP2023/008855, filed on Mar. 8, 2023.

(30) Foreign Application Priority Data
Mar. 23, 2022 (JP) 2022-047091
Feb. 27, 2023 (JP) 2023-028101

(51) Int. Cl. G01S 7/4865; G01S 7/48; G01S 17/931

(52) U.S. Cl. CPC G01S 7/4865; G01S 7/4802; G01S 17/931

(57) ABSTRACT

A light emitting unit emits emission light toward a predetermined emission range. A light receiving unit receives reflected light corresponding to the emission light. A distance calculation unit calculates a distance to the object using a time from the emission of the light to reception of the reflected light. A pulse detection unit detects at least one of a pulse width of the light reception signal at a predetermined threshold or a falling slope of the light reception signal. A reflection characteristic acquisition unit acquires a reflection characteristic including at least one of a reflection intensity or a reflectance of the object. When the light reception signal is saturated, the reflection characteristic acquisition unit acquires the reflection characteristic using at least one of the pulse width or the falling slope.

### CROSS REFERENCE TO RELATED APPLICATION

The present application is a continuation application of International Patent Application No. PCT/JP2023/008855 filed on Mar. 8, 2023, which designated the U.S. and claims the benefit of priority from Japanese Patent Applications No. 2022-47091, filed on Mar. 23, 2022, and No. 2023-28101, filed on Feb. 27, 2023. The entire disclosures of all of the above applications are incorporated herein by reference.

### TECHNICAL FIELD

The present disclosure relates to an object detection apparatus and an object detection method.

### BACKGROUND

There is known a technique of recognizing a detection target and measuring a distance to the detection target.

### SUMMARY

According to an aspect of the present disclosure, an object detection apparatus is configured to detect an object by reflected light from the object.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing a vehicle equipped with an object detection apparatus according to an embodiment and an emission range of emission light;

FIG. 2 is a block diagram showing a schematic configuration of the object detection apparatus;

FIG. 3 is an explanatory diagram showing a light reception signal when the light reception signal is saturated;

FIG. 4 is an explanatory diagram showing a relationship between a reflection surface angle and the light reception signal;

FIG. 5 is a flowchart of object detection processing performed by a CPU;

FIG. 6 is a detailed explanatory diagram of extraction of a reflection point and a proximity point performed by the CPU;

FIG. 7 is an explanatory diagram showing the reflection point and an adjacent reflection point;

FIG. 8 is a detailed explanatory diagram of calculation of the reflection surface angle performed by the CPU;

FIG. 9 is an explanatory diagram showing a relationship among a horizontal vector, a vertical vector, a normal vector, and a sensor vector;

FIG. 10 is a flowchart showing calculation of the reflection surface angle based on the vertical vector and the sensor vector;

FIG. 11 is a flowchart showing determination of whether three points are aligned on a straight line;

FIG. 12 is an explanatory diagram showing a positional relationship between three points;

FIG. 13 is an explanatory diagram showing a case where an object is a lane line drawn on a road;

FIG. 14 is a detailed explanatory diagram of averaging processing performed by the CPU;

FIG. 15 is an explanatory diagram showing a signal rate;

FIG. 16 is an explanatory diagram showing signals of the reflection point and a proximity point around the reflection point;

FIG. 17 is a detailed explanatory diagram of background light correction performed by the CPU;

FIG. 18 is an explanatory diagram showing a background light rate;

FIG. 19 is an explanatory diagram showing correction of a pulse width of the light reception signal according to the background light rate;

FIG. 20 is an explanatory diagram showing correction of a falling slope of the light reception signal according to the background light rate;

FIG. 21 is an explanatory diagram showing correction of the signal rate of the light reception signal according to the background light rate;

FIG. 22 is a detailed explanatory diagram of reflection characteristic acquisition performed by the CPU;

FIG. 23 is an explanatory diagram showing a relationship between the pulse width of the light reception signal and a logarithm of a signal intensity of the light reception signal;

FIG. 24 is an explanatory diagram showing a relationship between the falling slope of the light reception signal and the logarithm of the signal intensity of the light reception signal;

FIG. 25 is an explanatory diagram showing a relationship between the signal rate of the light reception signal and the logarithm of the signal intensity of the light reception signal;

FIG. 26 is an explanatory diagram showing a relationship between the reflection surface angle and a correction coefficient;

FIG. 27 is a detailed explanatory diagram of thicket correction performed by the CPU;

FIG. 28 is an explanatory diagram showing a thicket feature;

FIG. 29 is an explanatory diagram showing a case where the object is a lane line on a road surface;

FIG. 30 is an explanatory diagram showing thicket determination performed by the CPU in detail;

FIG. 31 is an explanatory diagram showing another method for obtaining the falling slope of the light reception signal by a falling slope detection unit;

FIG. 32 is an explanatory diagram showing another method for obtaining the falling slope of the light reception signal by the falling slope detection unit;

FIG. 33 is an explanatory diagram showing a method for ensuring continuity of a reflection characteristic of the light reception signal during switching between when the light reception signal is saturated and when the light reception signal is not saturated;

FIG. 34 is an explanatory diagram showing a signal intensity of reflected light when a reflectance of the object is high;

FIG. 35 is a flowchart showing another embodiment of specifying a reflector;

FIG. 36 is an explanatory diagram showing an example of visualizing a reflectance of the reflector;

FIG. 37 is a flowchart showing still another embodiment of specifying the reflector;

FIG. 38 is a block diagram showing a schematic configuration of an object detection apparatus mounted on a vehicle according to a second embodiment;

FIG. 39 is a flowchart showing light reception signal correction processing in the second embodiment;

FIG. 40 is an explanatory diagram showing an example of extracting a road shoulder and a lane line;

FIG. 41 is an explanatory diagram showing an angle formed by emission light and a normal of a target object; and

FIG. 42 is a flowchart showing processing of acquiring a reflection characteristic of the target object.

### DETAILED DESCRIPTION

Hereinafter, examples of the present disclosure will be described.

An object detection apparatus according to an example of the present disclosure measures a distance to a distance measurement target object by projecting pulsed light to the distance measurement target object, receiving reflected light from the target object, and measuring a time from when the pulsed light is projected to when the reflected light is received.

A distance measurement apparatus according to an example of the present disclosure sets two types of thresholds, and obtains, when reflected light is received, an intensity (signal intensity) of the reflected light based on a difference between rising times of a signal obtained from the reflected light to improve accuracy of distance measurement. However, in this distance measurement apparatus, when the target object is detected, the difference in the rising times hardly occurs in a case where the reflected light from the target object is strong. Therefore, it is difficult to detect a difference in the intensity (signal intensity) of the reflected light. Therefore, in this distance measurement apparatus, there is a problem that it is difficult to detect the difference in the intensity (signal intensity) of the reflected light even when the distance to the target object is known. This problem is significant when the signal intensity obtained from the reflected light is in a saturated region of a light receiving device that receives the reflected light.

According to an example of the present disclosure, an object detection apparatus is configured to detect an object by reflected light from the object. The object detection apparatus comprises:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal; and
a reflection characteristic acquisition unit configured to acquire a reflection characteristic including at least one of a reflection intensity or a reflectance of the object. When the light reception signal is saturated, the reflection characteristic acquisition unit is configured to acquire the reflection characteristic using at least one of the pulse width or the falling slope.

According to the object detection apparatus in this aspect, it is possible to detect a difference in an intensity (signal intensity) of the reflected light even when an intensity of the light reception signal is in a saturated region of the light receiving unit.

The present disclosure can be implemented in various forms. For example, in addition to the object detection apparatus, the present disclosure can be implemented in forms of a distance measurement method, a correction apparatus for an object detection apparatus, a correction method, and the like.

### A. First Embodiment

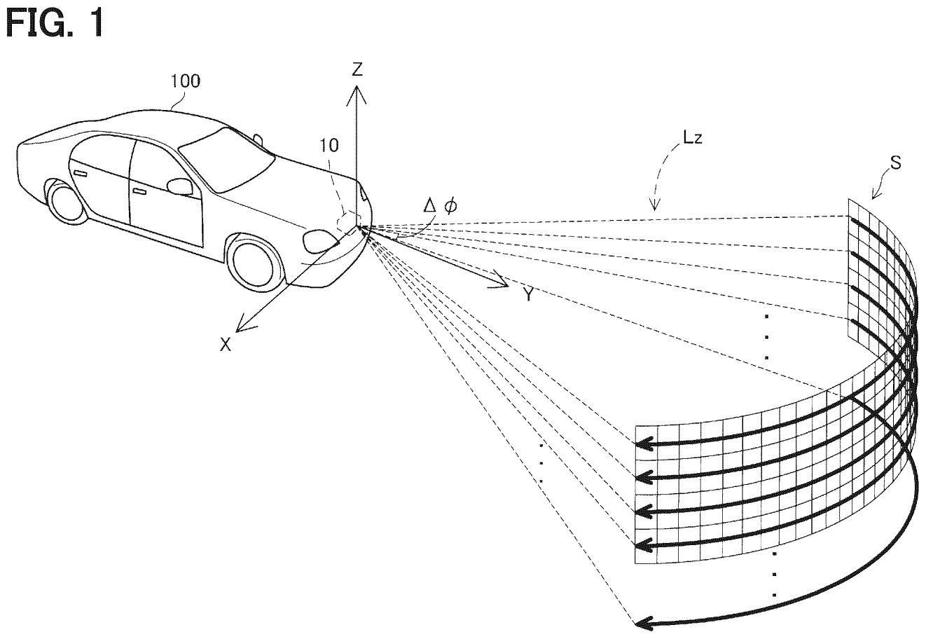

As shown in FIG. 1, an object detection apparatus 10 according to the present embodiment is mounted on a vehicle 100 and measures a distance to an object, for example, another vehicle, a pedestrian, or a building around the front of the vehicle 100 to detect the object. In the present embodiment, the object detection apparatus 10 includes light detection and ranging (LiDAR). The object detection apparatus 10 emits emission light Lz, which is pulsed light, to a predetermined emission range S while performing scanning, and receives reflected light corresponding to the emission light Lz. For example, if there is an object in the emission range S, the emission light Lz is incident on the object, and the reflected light is returned from the object. The object detection apparatus 10 receives the reflected light and detects the distance to the object. The object detection apparatus 10 may receive the reflected light and detect what the object is.

In FIG. 1, an emission center position of the emission light Lz is an origin, a front-rear direction of the vehicle 100 is a Y-axis, a width direction of the vehicle 100 passing through the origin is an X-axis, and a vertical direction passing through the origin is a Z-axis. A forward direction of the vehicle 100 is defined as a +Y direction, a rearward direction of the vehicle 100 is defined as a −Y direction, a rightward direction of the vehicle 100 is defined as a +X direction, a leftward direction of the vehicle 100 is defined as a −X direction, a vertically upward direction is defined as a +Z direction, and a vertically downward direction is defined as a −Z direction. The emission light Lz is emitted by one-dimensional scanning in a direction parallel to an X-Y plane. As indicated by a thick solid arrow in FIG. 1, the emission light Lz is emitted while performing scanning from left to right in the forward direction of the vehicle 100. Since the emission light Lz is pulsed light, a place to which each pulse is emitted is indicated by each grid cell indicated by thin solid lines. The emission light Lz is emitted at an angle corresponding to a resolution Δφ of the object detection apparatus 10. The resolution Δφ means an angle formed by a laser emission axis and the Y-axis in a Y-Z plane.

The object detection apparatus 10 detects the object as a distance measurement point cloud by measuring a time from emission of the emission light Lz to reception of the reflected light, that is, a time of flight TOF of the light, and calculating a distance to the object based on the time of flight TOF. A distance measurement point means a point indicating a position where at least a part of the object specified by the reflected light can be located in a range measurable by the object detection apparatus 10. The distance measurement point cloud means a collection of distance measurement points in a predetermined period. The object detection apparatus 10 detects the object, using a shape specified by three-dimensional coordinates of the detected distance measurement point cloud and reflection characteristics of the distance measurement point cloud.

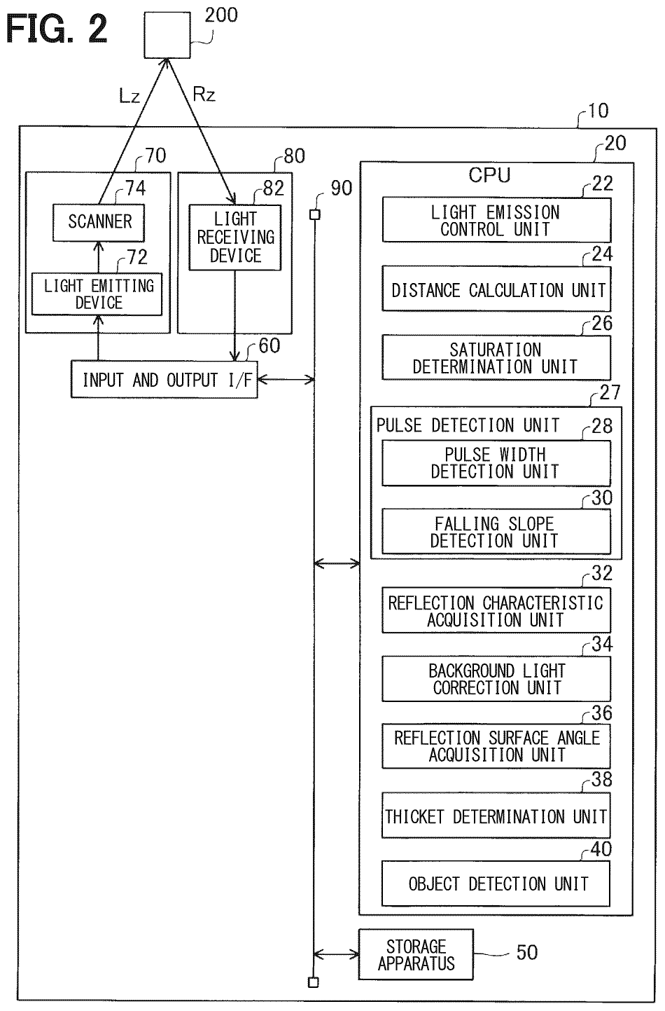

As shown in FIG. 2, the object detection apparatus 10 includes a CPU 20, a storage apparatus 50, an input and output interface 60, a light emitting unit 70, and a light receiving unit 80. The CPU 20, the storage apparatus 50, and the input and output interface 60 are connected via a bus 90 to enable bidirectional communication. The storage apparatus 50 includes a solid storage apparatus in addition to a semi-conductor storage apparatus such as a ROM, a RAM, and an EEPROM. The light emitting unit 70 and the light receiving unit 80 are connected to the input and output interface 60.

The CPU 20 functions as a light emission control unit 22, a distance calculation unit 24, a saturation determination unit 26, a pulse width detection unit 28, a falling slope detection unit 30, a reflection characteristic acquisition unit 32, a background light correction unit 34, a reflection surface angle acquisition unit 36, a thicket determination unit 38, and an object detection unit 40 by reading and executing a computer program stored in the storage apparatus 50. A detection unit including at least one of the pulse width detection unit 28 and the falling slope detection unit 30 is also referred to as a “pulse detection unit 27”. The light emission control unit 22, the distance calculation unit 24, the saturation determination unit 26, the pulse width detection unit 28, the falling slope detection unit 30, the reflection characteristic acquisition unit 32, the background light correction unit 34, the reflection surface angle acquisition unit 36, the thicket determination unit 38, and the object detection unit 40 may be implemented as separate apparatuses that operate according to an instruction from the CPU 20.

The light emission control unit 22 transmits a light emission signal to the light emitting unit 70 at a regular interval via the input and output interface 60. The light emitting unit 70 includes a light emitting device 72 and a scanner 74. Upon receiving the light emission signal, the light emitting unit 70 emits the emission light Lz from the light emitting device 72. The light emitting device 72 includes, for example, an infrared laser diode, and emits infrared laser light as the emission light Lz. The scanner 74 includes, for example, a mirror or a digital mirror device (DMD), and performs scanning with the emission light emitted from the light emitting device 72 from the −X direction to the +X direction and from the −Z direction to the +Z direction at a regular interval. The number of the light emitting devices 42 may be one or multiple. When multiple light emitting devices 42 are provided along the Z-axis direction, for example, scanning from the −Z direction to the +Z direction may be omitted.

The light receiving unit 80 includes multiple light receiving devices 82. The light receiving device 82 includes m×n single photon avalanche diodes (SPADs) two-dimensionally arranged in an X-Z direction. In each light receiving device 82, one pixel is formed by p×q SPADs in two-dimensional arrangement of p×q. Here, p and q are each an integer of 2 or more. Accordingly, the light receiving unit 80 has (m/p)×(n/q) pixels. In the above-described m×n SPADs, m is preferably an integer that is an integral multiple of p, and n is preferably an integer that is an integral multiple of q. Based on by which pixel reflected light Rz is received, the CPU 10 recognizes from which direction the reflected light Rz is returned, that is, a direction of a reflection point (distance measurement point) of the emission light Lz on an object 200, a declination and an elevation angle in a three-dimensional polar coordinate system. Instead of using coordinates of the light receiving device 82, the CPU 10 may use an angle of the scanner 74 to acquire the direction from which the reflected light Rz is returned, that is, the direction of the reflection point (distance measurement point) of the emission light Lz on the object 200. The light receiving unit 80 can be downsized.

The distance calculation unit 24 calculates a distance D from the object detection apparatus 10 to the reflection point of the object 200, using the time TOF from when the light emitting device 72 emits the emission light Lz to when the emission light Lz is incident on the object 200 and the reflected light Rz thereof is received by the light receiving device 82 of the light receiving unit 80. The distance D from the object detection apparatus 10 to the reflection point of the object 200 is TOF/(2·c), where c is the speed of light. Since a distance (a radial distance in a three-dimensional coordinate system) to the object 200 is known based on the time of flight TOF, the CPU 20 can calculate three-dimensional coordinates of the reflection point (distance measurement point), using the distance (radial distance) to the object 200 and a direction (a declination and an elevation angle).

The saturation determination unit 26 determines whether a light reception signal generated by light reception of the light receiving device 82 is saturated. The saturation determination unit 26 determines that the light reception signal is saturated when a light reception signal generated by the light receiving device 82 of one pixel is equal to or larger than a maximum value (hereinafter, referred to as “saturation intensity”) of the light reception signal that can be generated by the light receiving device 82 of one pixel. As described above, the light receiving device 82 of one pixel is formed of 3×6 SPADs, and can detect up to p×q×r photons in the reflected light Rz corresponding to pulse r cycles (r is an integer of 2 or more) of the emission light Lz. When s % or more, that is, p×q×r×s/100 or more photons in the reflected light Rz for r cycles are detected, the saturation determination unit 26 determines that the light reception signal is saturated at the pixel. Here, s is a predetermined number smaller than 100 and is, for example, 95.

The pulse width detection unit 28 detects, as a pulse width, a time from when the light reception signal rises and reaches a predetermined magnitude to when the light reception signal falls and reaches the predetermined magnitude. The falling slope detection unit 30 detects a slope of the light reception signal when the light reception signal falls.

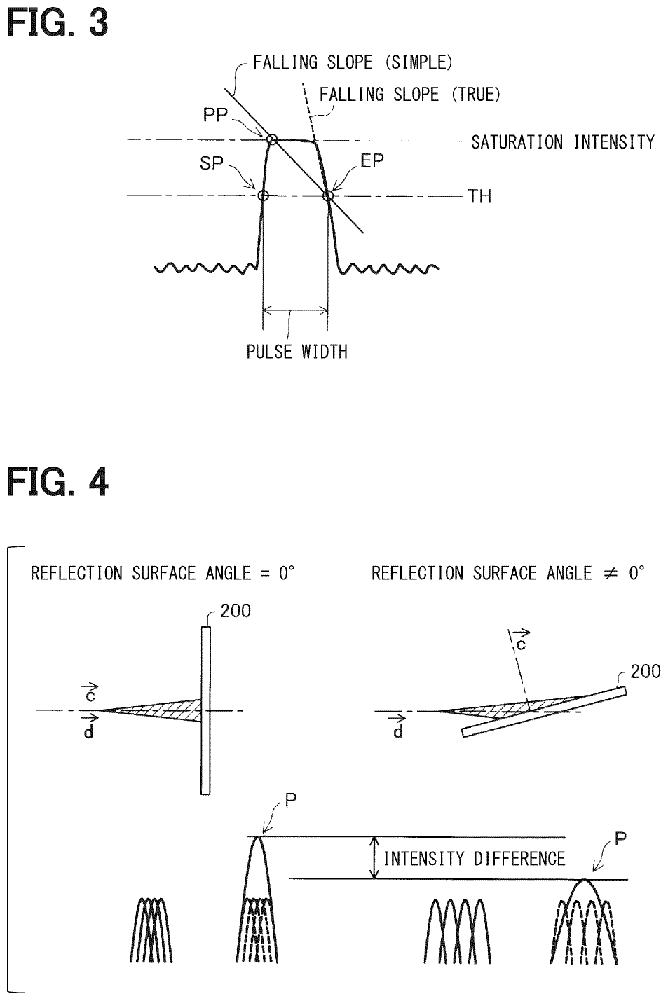

FIG. 3 is an explanatory diagram showing a light reception signal when the light reception signal is saturated. A position where the light reception signal rises and reaches the saturation intensity is referred to as a peak point PP. The pulse width detection unit 28 sets a length of a period in which the light reception signal is equal to or larger than a predetermined threshold TH as the pulse width. A start point of the pulse width is called a start point SP, and an end point of the pulse width is called an end point EP. A falling slope is a slope when the light reception signal falls. However, since it is difficult to acquire the slope when the light reception signal falls, the falling slope detection unit 30 regards a rate of change over time as the falling slope of the light reception signal. The rate of change over time is a value obtained by dividing a difference between the saturation intensity of the light reception signal and the threshold TH by a time difference from a timing when the light reception signal reaches the peak point PP to a timing when the light reception signal reaches the end point EP.

The reflection characteristic acquisition unit 32 in FIG. 2 acquires a reflection characteristic of the object 200. The reflection characteristic of the object 200 means a reflection intensity or a reflectance of the object 200. The reflection intensity of the object 200 is an absolute intensity of the reflected light reflected by the object 200, and increases as a distance from the light emitting unit 70 to the object 200 decreases. The reflectance is a value obtained by dividing an intensity of the reflected light Rz by an intensity of the emission light, and does not depend on the distance from the light emitting unit 70 to the object 200.

The background light correction unit 34 corrects the reflected light Rz of the object 200 to remove an influence of background light. The reflection surface angle acquisition unit 36 acquires an angle θ (hereinafter, referred to as “reflection surface angle θ”) formed by a normal of the object 200 at the distance measurement point of the object 200 and the reflected light Rz. A reason why the reflection surface angle acquisition unit 36 acquires the reflection surface angle is to acquire a net intensity of the reflected light of the object 200 since the intensity of the reflected light Rz differs depending on the reflection surface angle.

FIG. 4 is an explanatory diagram showing a relationship between the reflection surface angle θ and the light reception signal. When the reflection surface angle, which is an angle formed by a vector c that is a normal of the reflection point of the object 200 and a sensor vector d that is a vector from the light receiving unit 80 toward the reflection point, is 0°, a direction of the emission light Lz is substantially parallel to a direction of a normal of a surface of the object 200. As a result, a signal intensity of the reflected light Rz of the object 200 is high. On the other hand, when the reflection surface angle θ is not 0°, the direction of the emission light Lz is not parallel to the direction of the normal of the surface of the object 200. As a result, since the emission light Lz is obliquely incident on the surface of the object 200, the signal intensity of the reflected light Rz of the object 200 is smaller than that in the case where the reflection surface angle θ is 0°. A width of the reflected light Rz is increased. Therefore, the CPU 20 acquires the reflection surface angle θ by the reflection surface angle acquisition unit 36 and uses the reflection surface angle θ to correct the light reception signal. Such correction will be described later.

The thicket determination unit 38 in FIG. 2 determines whether a measurement point of the object 200 is in a thicket using a distance to the reflection point on the object 200 and an adjacent reflection point in the vicinity of the reflection point, and a variation in the reflection characteristic. The object detection unit 40 detects what the object 200 is, for example, whether the object 200 is a lane line on a road, using the reflection characteristic of the object 200 and the distance to the object 200. Although the reflection characteristic of the object 200 is acquired, the object detection unit 40 can be omitted if it is not necessary to detect what the object 200 is.

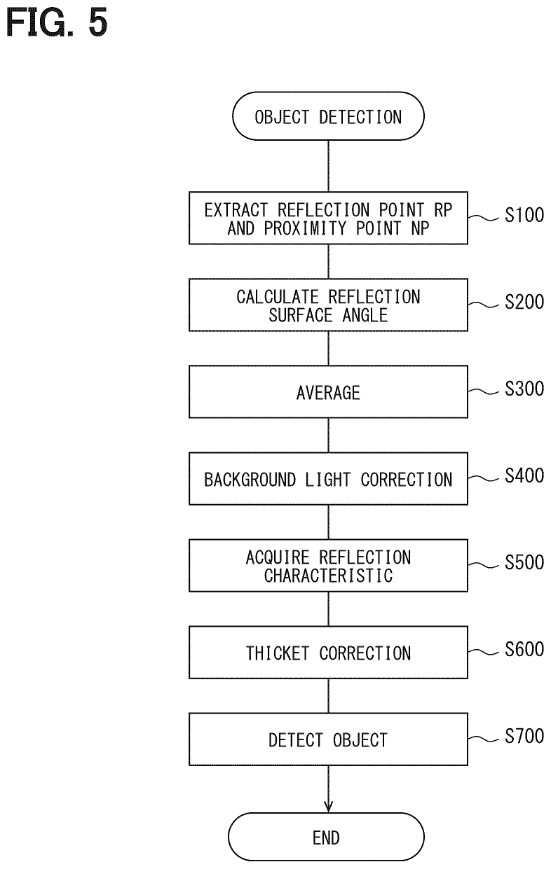

FIG. 5 is a processing flowchart performed by the CPU 20. When the vehicle 100 is started, the CPU 20 repeatedly executes processing shown in FIG. 5. In step S100, the CPU 20 extracts a reflection point RP and a proximity point NP around the reflection point RP. In step S200, the CPU 20 calculates the reflection surface angle of the object 200. In step S300, the CPU 20 averages the light reception signal. In step S400, the CPU 20 performs background light correction to remove the influence of the background light from the light reception signal. In step S500, the CPU 20 acquires the reflection characteristic of the object 200. In step S600, the CPU 20 determines whether the measurement point of the object 200 is in a thicket, that is, whether the object 200 is a thicket. When the object 200 is a thicket, thicket correction is performed. In step S700, the CPU 20 detects what the object 200 is. When the CPU 20 does not detect what the object 200 is, the CPU 20 may not perform the processing in step S700. Details of the above-described steps will be described later.

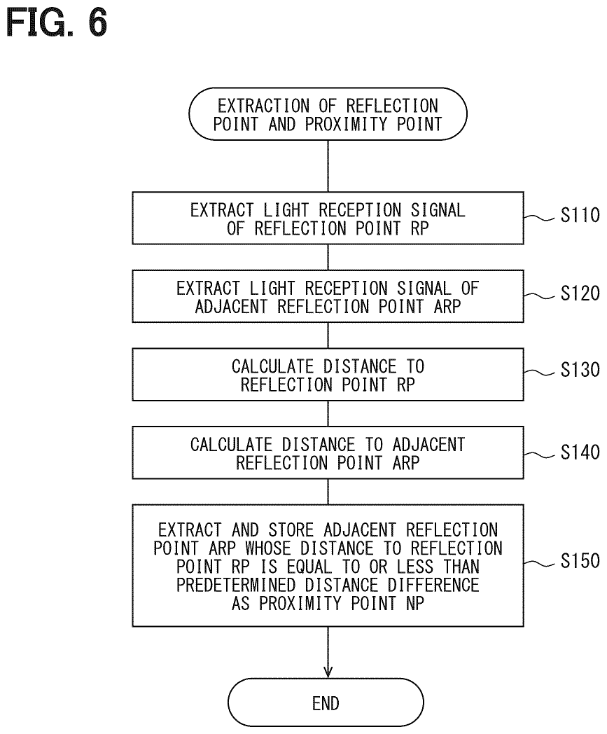

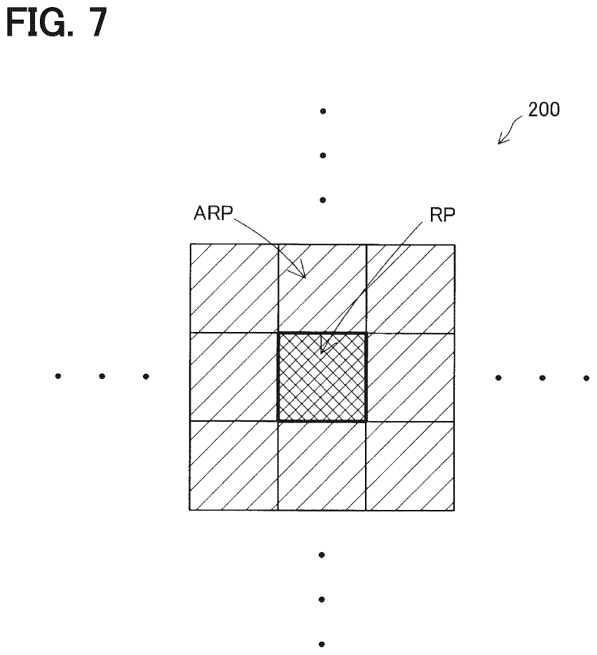

FIG. 6 is a detailed explanatory diagram of step S100 performed by the CPU 20. In step S110, the CPU 20 extracts the light reception signal of the reflected light Rz reflected from the reflection point RP of the object 200. In step S120, the CPU 20 extracts the light reception signal of the reflected light Rz reflected from the adjacent reflection point ARP around the reflection point RP. As shown in FIG. 7, the adjacent reflection point ARP is a point around the reflection point RP. The reflected light from the adjacent reflection point ARP is detected by a pixel around a pixel where the reflected light from the reflection point RP on the light receiving unit 80 is detected. In the example shown in FIG. 7, a range of the adjacent reflection point ARP is a range of 3×3 pixels around the reflection point RP, and may alternatively be a range of 5×5 pixels around the reflection point RP.

In step S130, the CPU 20 causes the distance calculation unit 24 to calculate a distance to the reflection point RP. In step S140, the CPU 20 causes the distance calculation unit 24 to calculate a distance to the adjacent reflection point ARP. In step S150, the CPU 20 extracts the adjacent reflection point ARP whose distance to the reflection point RP is equal to or less than a certain distance difference as the proximity point NP, and stores the proximity point NP in the storage apparatus 50. The reflection point RP and the adjacent reflection point ARP whose distance to the reflection point RP is equal to or less than the certain distance difference can be considered as being located on the same object 200.

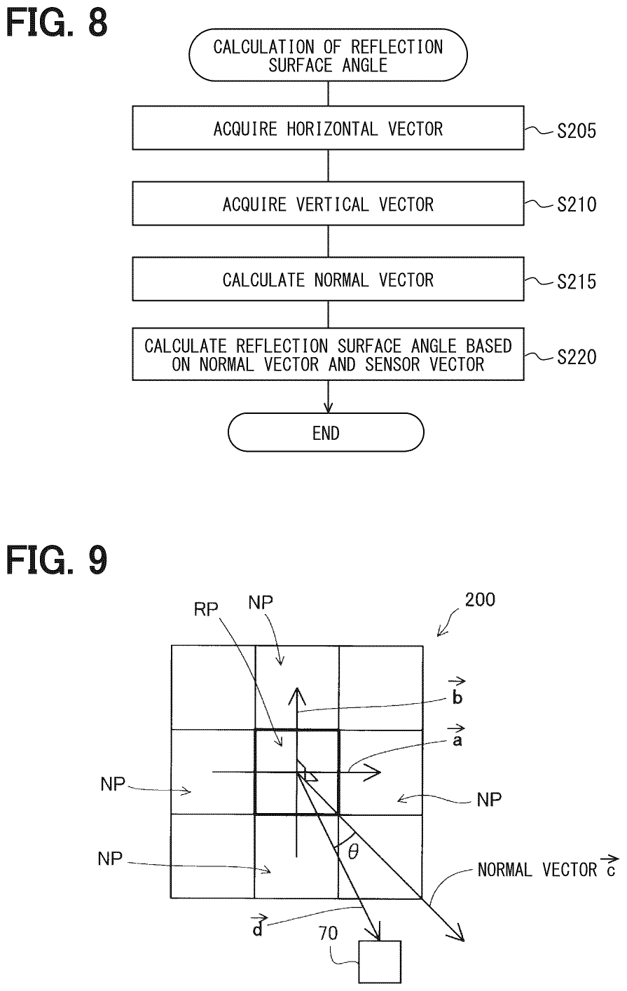

FIG. 8 is a detailed explanatory diagram of step S200 performed by the CPU 20. In step S205, the CPU 20 obtains a horizontal vector a, which is a direction vector in a horizontal direction, using the reflection surface angle acquisition unit 36. As shown in FIG. 9, the horizontal vector a is a vector connecting the proximity points NP interposing the reflection point RP from right and left. The CPU 20 can calculate the horizontal vector a by using a distance to each proximity point NP and coordinates of the light receiving device 82 corresponding to each proximity point NP. In step S210 in FIG. 8, the CPU 20 obtains a vertical vector b, which is a direction vector in a vertical direction, using the reflection surface angle acquisition unit 36. As shown in FIG. 9, the vertical vector b is a vector connecting the proximity points NP interposing the reflection point RP from above and below. The CPU 20 can calculate the vertical vector b by using a distance to each proximity point NP and coordinates of the light receiving device 82 corresponding to each proximity point NP.

In step S215, the CPU 20 calculates the normal vector c of the reflection point RP based on the horizontal vector a and the vertical vector b, using the reflection surface angle acquisition unit 36. More specifically, the CPU 20 obtains an outer product of the horizontal vector a and the vertical vector b, and regards the outer product as the normal vector c of the reflection point of the object 200. That is, the normal vector c of the reflection point of the object 200 is a×b.

In step S220, the CPU 20 calculates the angle θ formed by the normal vector c and the sensor vector d, using the reflection surface angle acquisition unit 36, and regards the angle θ as the reflection surface angle. The sensor vector d is a vector connecting the reflection point RP and the light receiving device 82. The CPU 20 calculates the sensor vector d using the distance to the reflection point RP and coordinates of the light receiving device 82 corresponding to the reflection point RP. Since there is a relationship of c·d=|c|·|d|·cos θ between the angle θ formed by the normal vector c and the sensor vector d, the normal vector c, and the sensor vector d, the CPU 20 calculates the angle θ (reflection surface angle θ), using this relationship.

By the above-described method, the CPU 20 obtains the horizontal vector a and the vertical vector b, obtains the normal vector c based on the horizontal vector a and the vertical vector b, and obtains the reflection surface angle θ based on the normal vector c and the sensor vector d. Vectors for obtaining the normal vector c may not be the horizontal vector a and the vertical vector b. For example, two vectors oblique to the horizontal direction and the vertical direction may be used. Alternatively, the calculation may be simply performed using one of the horizontal vector a and the vertical vector b.

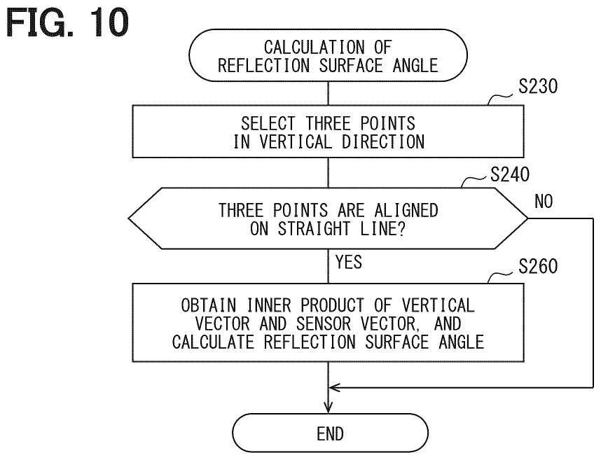

As shown in FIG. 10, the CPU 20 may calculate the reflection surface angle θ, using the vertical vector b and the sensor vector d. In step S230, the CPU 20 selects three points in the vertical direction. The three points may be the reflection point RP and the two proximity points NP interposing the reflection point RP from above and below. In step S240, the CPU 20 determines whether the selected three points are aligned on a straight line. When the selected three points are aligned on a straight line, the CPU 20 transitions the processing to step S260.

In step S260, the CPU 20 obtains an inner product of the vertical vector b passing through the selected three points and the sensor vector d, and calculates the reflection surface angle θ, using a relationship of the following equation b·d=|b|·|d|·cos(θ+90°).

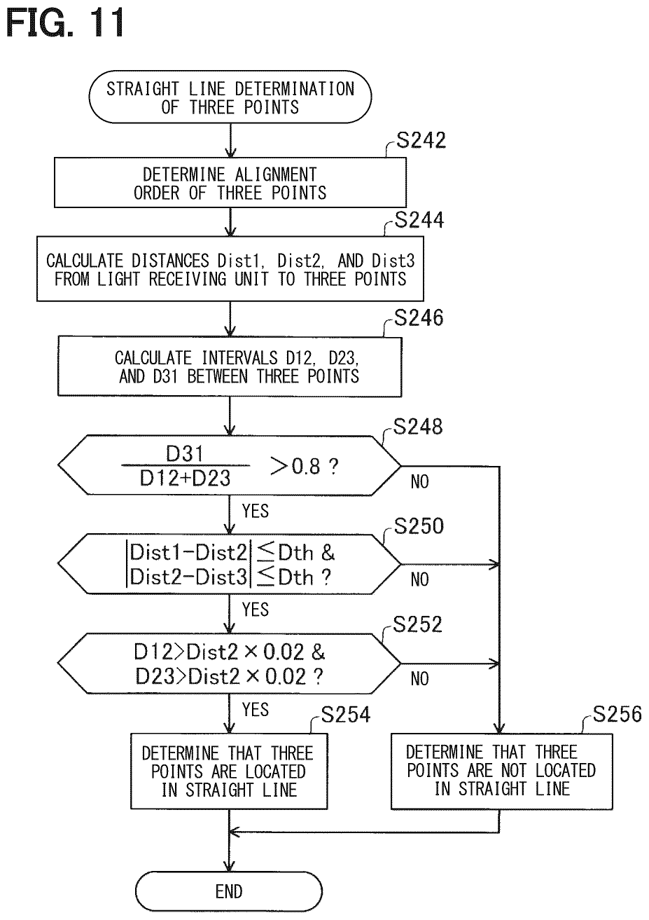

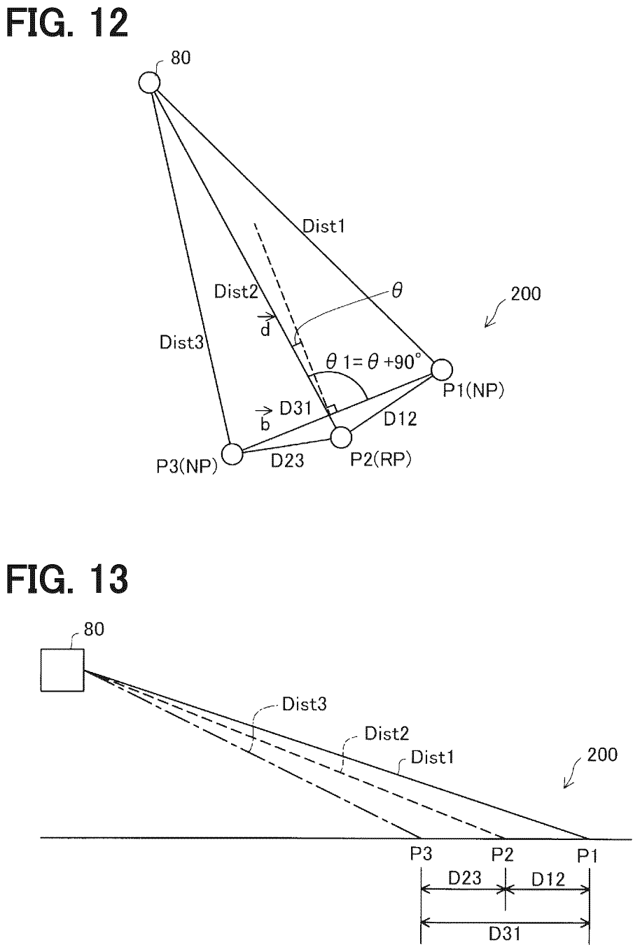

As shown in FIG. 11, the CPU 20 determines whether the selected three points are aligned on a straight line. In step S242, the CPU 20 determines an alignment order of three points P1, P2, and P3. As shown in FIG. 12, the CPU 20 determines the alignment order of the three points P1, P2, and P3 such that the point P1 is located above and the point P3 is located below with the point P2 located at the center. The point P2 may be, for example, the reflection point RP, and the points P1 and P3 may be the proximity points NP.

In step S244 in FIG. 11, the CPU 20 acquires a time from when the light emitting unit 70 emits the emission light Lz to when the emission light Lz is reflected at the points P1, P2, and P3 and the reflected light Rz is detected by the light receiving unit 80. Based on this time, the distance calculation unit 24 calculates distances Dist1, Dist2, and Dist3.

In step S246, the CPU 20 calculates three-dimensional coordinates of the three points P1, P2, and P3 using the distances Dist1, Dist2, and Dist3 from the light receiving unit 80 to the three points P1, P2, and P3 and coordinates of the light receiving devices 82 corresponding to the points P1, P2, and P3. Then, intervals D12, D23, and D31 between the three points P1, P2, and P3 are calculated. Due to a positional relationship among the points P1, P2, and P3, the interval D31 is larger than the intervals D12 and D23.

In step S248, the CPU 20 determines whether the largest interval D31 is larger than 0.8 times a sum of the remaining two intervals D12 and D23. When the interval D31 is larger than 0.8 times the sum of the intervals D12 and D23, the three points P1, P2, and P3 can be regarded as being located in a straight line, and thus the CPU 20 transitions the processing to step S250. Considering a triangle formed by the three points P1, P2, and P3, the interval D31 is not larger than the sum of the intervals D12 and D23. On the other hand, when the interval D31 is not larger than 0.8 times the sum of the intervals D12 and D23, a possibility that the three points P1, P2, and P3 are located in a straight line is low, and thus the processing transitions to step S256.

In step S250, the CPU 20 determines whether a difference between the distance Dist1 and the distance Dist2 is equal to or less than a predetermined threshold Dth and a difference between the distance Dist2 and the distance Dist3 is equal to or less than the predetermined threshold Dth. When the difference between the distance Dist1 and the distance Dist2 is equal to or less than the predetermined threshold Dth and the difference between the distance Dist2 and the distance Dist3 is equal to or less than the predetermined threshold Dth, the CPU 20 transitions the processing to step S252. On the other hand, when the difference between the distance Dist1 and the distance Dist2 exceeds the predetermined threshold Dth or the difference between the distance Dist2 and the distance Dist3 exceeds the predetermined threshold Dth, the CPU 20 transitions the processing to step S256. This is for determining whether the points P1, P2, and P3 are too far from each other.

In step S252, the CPU 20 determines whether the interval D12 between the point P1 and the point P2 is larger than 0.02 times the distance Dist2 from the light receiving unit 80 to the point P2, and the interval D23 between the point P2 and the point P3 is larger than 0.02 times the distance Dist2 from the light receiving unit 80 to the point P2. When the interval D12 is larger than 0.02 times the distance Dist2 and the interval D23 is larger than 0.02 times the distance Dist2, the CPU 20 transitions the processing to step S254. On the other hand, when the interval D12 is equal to or less than 0.02 times the distance Dist2 or the interval D23 is equal to or less than 0.02 times the distance Dist2, the CPU 20 transitions the processing to step S256. This is because, when the points P1, P2, and P3 are too close to each other, accuracy in calculating the reflection surface angle θ decreases, and it is not possible to determine that the points P1, P2, and P3 are located in a straight line.

In step S254, since determination in all of steps S248, S250, and S252 is “Yes”, the CPU 20 determines that the three points P1, P2, and P3 are located in a straight line. On the other hand, in step S256, the CPU 20 determines that the three points P1, P2, and P3 are not located in a straight line.

FIG. 13 shows a case where the object 200 is a lane line drawn on a road. In this case, measurement is performed such that the point P1 is located above the point P2 and the point P3 is located below the point P2 with the point P2 as a center. The distance Dist1 from the light receiving unit 80 to the point P1 is the largest, and the distance Dist2 from the light receiving unit 80 to the point P2 and the distance Dist3 from the light receiving unit 80 to the point P3 are smaller in this order.

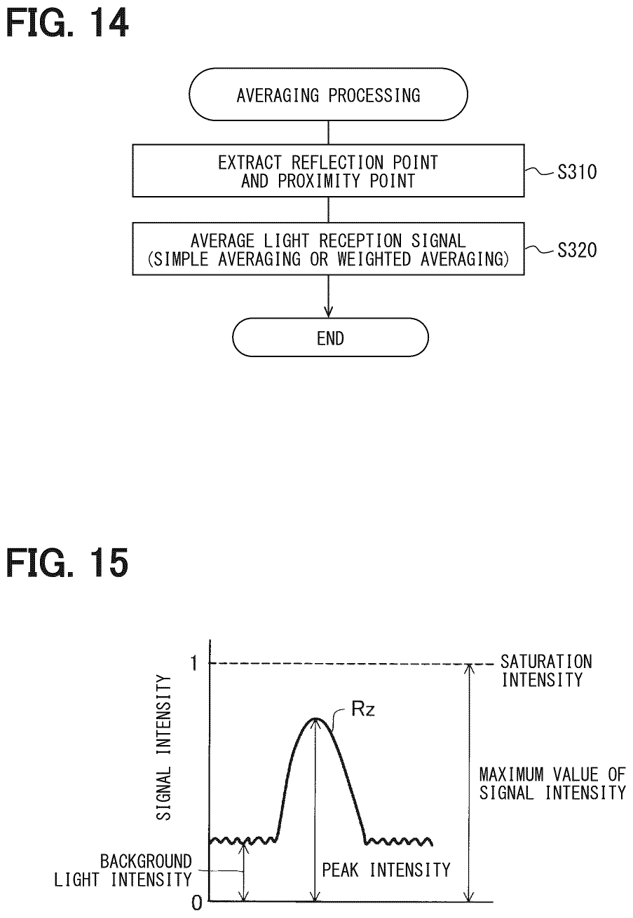

FIG. 14 is a detailed explanatory diagram of step S300 performed by the CPU 20. In step S310, the CPU 20 extracts the reflection point RP and the proximity reflection point. At this time, the CPU 20 may further extract, as the proximity point NP, only the proximity point NP of a point where a difference between a signal rate at the reflection point RP and a signal rate at the proximity point NP is equal to or less than a threshold.

FIG. 15 is an explanatory diagram showing the signal rate. The signal rate is a response rate of the SPAD with respect to an effective range of the SPAD excluding the influence of the background light. The signal rate is calculated by dividing a value obtained by subtracting an intensity of the background light from a signal intensity (peak intensity) of the light reception signal by a value obtained by subtracting the intensity of the background light from a maximum signal intensity (saturation intensity) of the light reception signal. That is, the signal rate means an intensity ratio of a difference between the intensity of the light reception signal and the intensity of the background light to a difference between the saturation intensity of the light reception signal and the intensity of the background light.

In step S320 in FIG. 14, the CPU 20 averages the intensity of the light reception signal. Specifically, when the light reception signal is not saturated, the CPU 20 averages the signal rate, and when the light reception signal is saturated, the CPU 20 averages the pulse width of the light reception signal and the falling slope of the light reception signal.

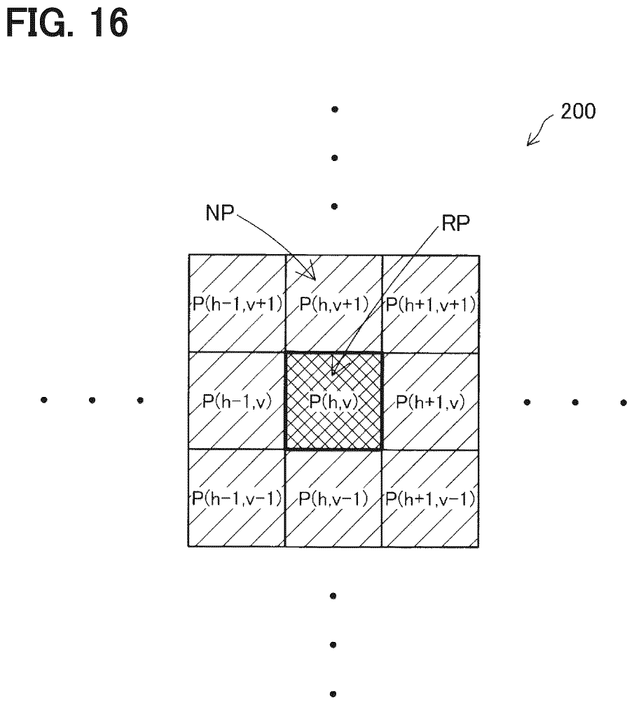

FIG. 16 shows signals P(h−1, v−1) to P(h+1, v+1) of reflection points (a signal P(h, v) at coordinates (h, v) and coordinates (h−1, v−1) to (h+1, v+1) of proximity points around the signal P(h, v), except for coordinates (h, v) of the reflection point). The CPU 20 calculates an average value Pave by the following equation. In the following equations (1) to (3), 9 is a sum of the reflection point and the proximity points.

$$\begin{matrix}[ Equation 1 ] & \\ Pave = ( {\sum }_{i = v - 1}^{v + 1} {\sum }_{j = h - 1}^{h + 1} P ( i , j ) ) / 9 & ( 1 )\end{matrix}$$

The CPU 20 may calculate a weighted average Pave2 by the following equation.

$$\begin{matrix}[ Equation 2 ] & \\ Pave2 = ( {\sum }_{i = v - 1}^{v + 1} {\sum }_{j = h - 1}^{h + 1} w ( i , j ) P ( i , j ) ) / 9 & ( 2 )\end{matrix}$$

In equation (2), w(i, j) is a weighting coefficient, and the following equation (3) is satisfied.

$$\begin{matrix}[ Equation 3 ] & \\ ( {\sum }_{i = v - 1}^{v + 1} {\sum }_{j = h - 1}^{h + 1} w ( i , j ) ) / 9 = 1 & \end{matrix} \qquad ( 3 )$$

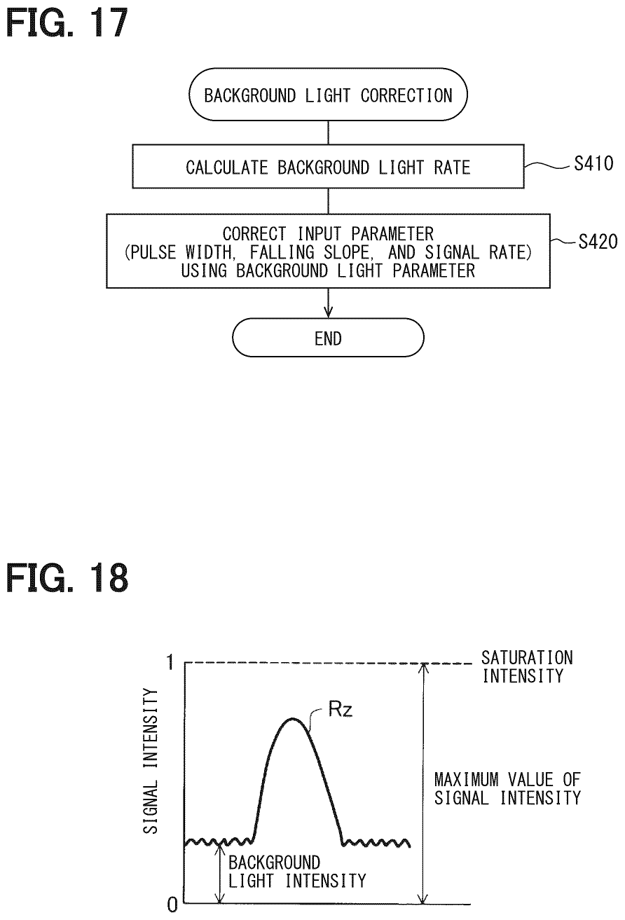

FIG. 17 is a detailed explanatory diagram of step S400 performed by the CPU 20. In step S410, the CPU 20 acquires a background light rate using the background light correction unit 34. FIG. 18 is an explanatory diagram showing the background light rate. The background light rate is obtained by normalizing a background light intensity in a range of 0 to 1, and is a value obtained by dividing the background light intensity by the maximum value (saturation intensity) of the signal intensity.

In step S420 in FIG. 17, the CPU 20 corrects an input parameter (the pulse width, the falling slope, and the signal rate of the light reception signal), using the background light rate. Specifically, as will be described later, the CPU 20 removes the influence of the background light on the pulse width and the falling slope when the light reception signal is saturated, and removes the influence of the background light on the intensity of the light reception signal when the light reception signal is not saturated.

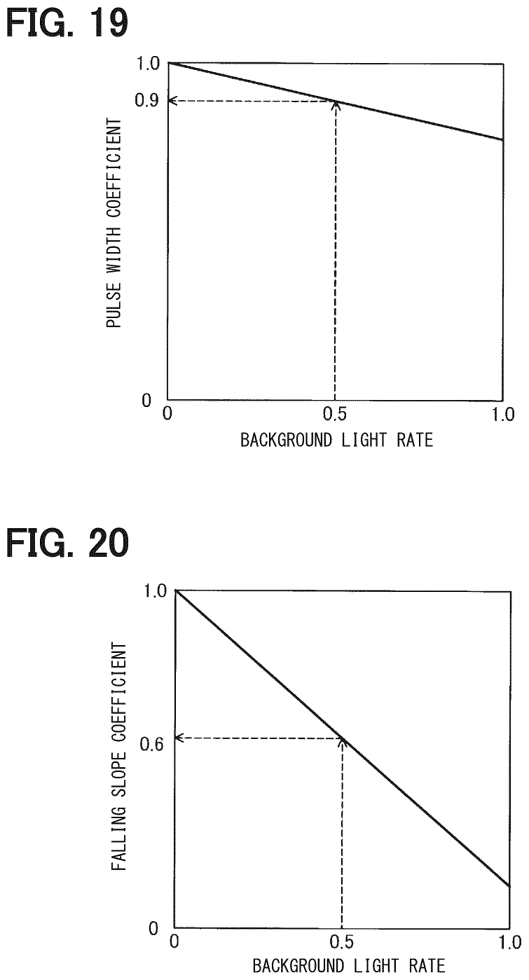

FIG. 19 is an explanatory diagram showing correction of the pulse width of the light reception signal according to the background light rate. A pulse width coefficient in FIG. 18 indicates how many times the pulse width of the light reception signal measured with respect to the background light rate is multiplied. In the example shown in FIG. 19, when the background light rate is 0.5, the CPU 20 multiplies the pulse width of the measured light reception signal by 0.9.

FIG. 20 is an explanatory diagram showing correction of the falling slope of the light reception signal according to the background light rate. A falling slope coefficient in FIG. 20 indicates how many times the falling slope of the light reception signal measured with respect to the background light rate is multiplied. In the example shown in FIG. 20, when the background light rate is 0.5, the CPU 20 multiplies the falling slope of the measured light reception signal by 0.6.

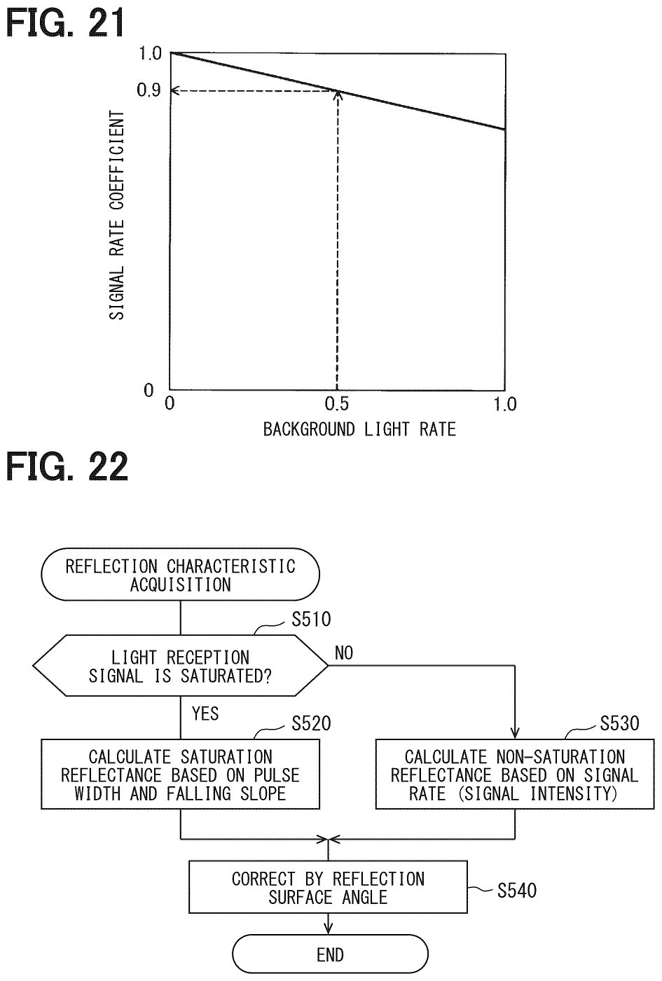

FIG. 21 is an explanatory diagram showing correction of the signal rate of the light reception signal according to the background light rate. A signal rate coefficient in FIG. 21 indicates how many times the signal rate of the light reception signal measured with respect to the background light rate is multiplied. In the example shown in FIG. 21, when the background light rate is 0.5, the CPU 20 multiplies the signal rate of the measured light reception signal by 0.9.

FIG. 22 is a detailed explanatory diagram of step S500 performed by the CPU 20. In step S510, the CPU 20 determines whether the light reception signal is saturated. As described above, when the light reception signal exceeds the saturation intensity, more specifically, when photons of s % or more of p×q are detected in the reflected light Rz, the CPU 20 determines that the light reception signal exceeds the saturation intensity. The light reception signal of several cycles may be integrated. When the light reception signal exceeds the saturation intensity, the CPU 20 transitions the processing to step S520. On the other hand, when the light reception signal is equal to or less than the saturation intensity, the CPU 20 transitions the processing to step S530.

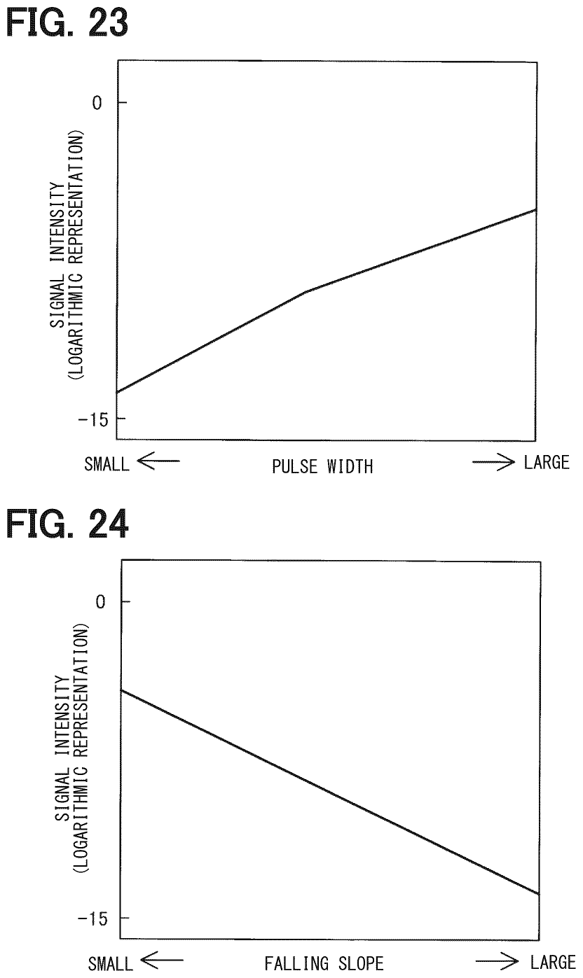

In step S520, the CPU 20 calculates a saturation reflectance RS by, using at least one of the pulse width and the falling slope of the light reception signal. As shown in FIG. 23, the CPU 20 acquires a logarithm of the signal intensity of the light reception signal based on the pulse width of the light reception signal. A relationship between the pulse width of the light reception signal and the signal intensity of the light reception signal is obtained in advance by an experiment. The CPU 20 calculates the signal intensity of the light reception signal based on the logarithm of the signal intensity of the light reception signal. Next, the CPU 20 calculates the reflectance of the object 200, using the signal intensity of the light reception signal and a distance Dist to the object 200. The reflectance of the object 200 is proportional to the signal intensity of the light reception signal and proportional to a square of the distance Dist to the object 200. When the distance Dist to the object 200 increases, the signal intensity of the light reception signal decreases.

As shown in FIG. 24, the CPU 20 acquires the logarithm of the signal intensity of the light reception signal based on the falling slope of the light reception signal. A relationship between the falling slope of the light reception signal and the signal intensity of the light reception signal is obtained in advance by an experiment. The CPU 20 calculates the signal intensity of the light reception signal based on the logarithm of the signal intensity of the light reception signal. Next, the CPU 20 calculates the reflectance of the object 200, using the signal intensity of the light reception signal and a distance Dist to the object 200.

In FIG. 23, the CPU 20 acquires the logarithm of the signal intensity of the light reception signal based on the pulse width of the light reception signal. In FIG. 24, the logarithm of the signal intensity of the light reception signal is acquired based on the falling slope of the light reception signal. Of course, the CPU 20 may acquire the logarithm of the signal intensity of the light reception signal using both the pulse width and the falling slope of the light reception signal.

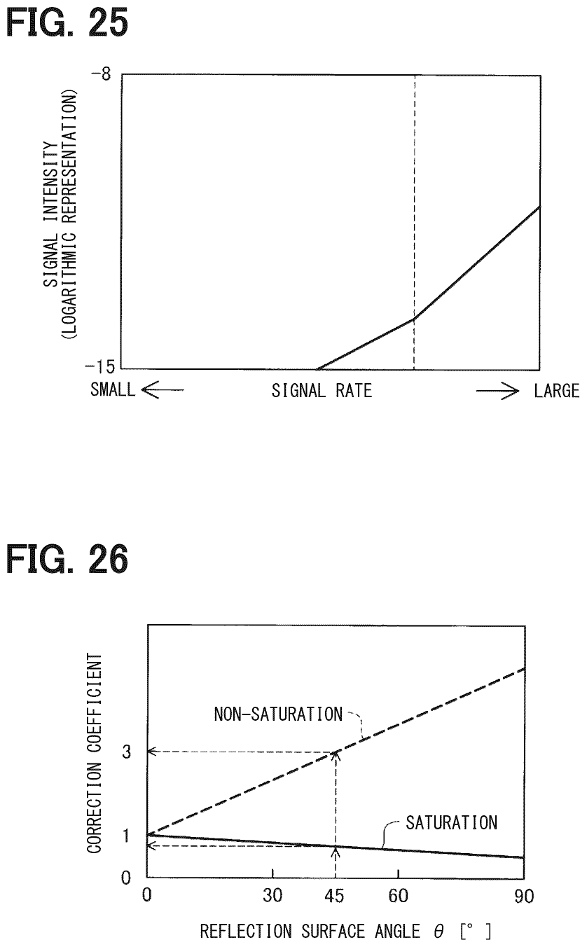

In step S530, the CPU 20 calculates a non-saturation reflectance RNS, using the signal rate of the light reception signal. As shown in FIG. 25, the CPU 20 acquires the logarithm of the signal intensity of the light reception signal based on the signal rate of the light reception signal. A relationship between the pulse width of the light reception signal and the signal intensity of the light reception signal is obtained in advance by an experiment. The CPU 20 calculates the signal intensity of the light reception signal based on the logarithm of the signal intensity of the light reception signal. Next, the CPU 20 calculates the reflectance of the object 200, using the signal intensity of the light reception signal and a distance Dist to the object 200. The CPU 20 may acquire the reflectance and the reflection characteristic of the object 200 using at least one of the signal intensity of the light reception signal and the pulse width of the light reception signal.

In step S540, the CPU 20 corrects the reflectance of the object 200 by using the reflection surface angle θ. FIG. 26 is an explanatory diagram showing a relationship between the reflection surface angle θ and a correction coefficient. A solid line indicates a case where the light reception signal is saturated, and a broken line indicates a case where the light reception signal is not saturated. When the light reception signal is saturated, the CPU 20 corrects, according to the reflection surface angle θ, the reflectance to be smaller at a magnification smaller than 1 since the pulse width increases as the reflection surface angle increases. On the other hand, when the light reception signal is not saturated, the signal rate decreases as the reflection surface angle increases, and thus the reflectance is corrected to be larger at a magnification larger than 1. In the case shown in FIG. 26, when the reflection surface angle θ is 0°, the correction coefficient is 1. When the reflection surface angle θ is 45°, the correction coefficient when the light reception signal is saturated is 0.75, and the correction coefficient when the light reception signal is not saturated is 3.

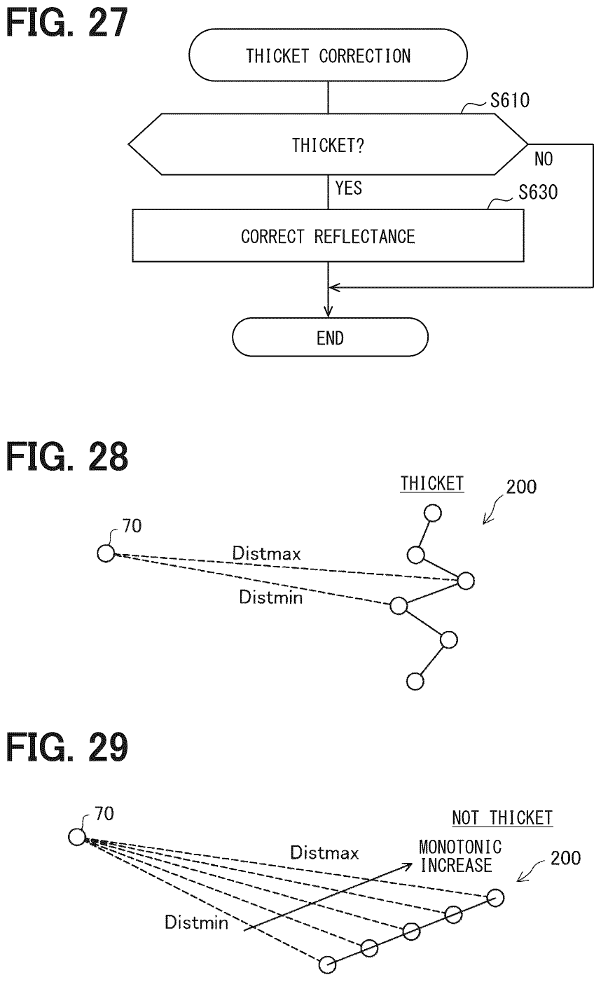

FIG. 27 is a detailed explanatory diagram of step S600 performed by the CPU 20. In step S610, the CPU 20 determines whether the object 200 that is an emission destination to which the emission light Lz is emitted by the light emitting unit 70 is a thicket. When it is determined that the object 200 is a thicket, the CPU 20 transitions the processing to step S630. On the other hand, when it is determined that the object 200 is not a thicket, the CPU 20 ends the processing without performing reflectance correction.

The determination of whether the object 200 is a thicket (step S610) is performed as follows. A case where the object 200 is a thicket (FIG. 28) and a case where the object 200 is a lane line on a road surface (FIG. 29) will be described as an example. As shown in FIG. 28, when the object 200 is a thicket, a distance difference between a minimum distance Distmin and a maximum distance Distmax from the light receiving unit 80 to the measurement point is large. The measurement point at which the distance from the light receiving unit 80 to the measurement point is the minimum distance Distmin is not always located at a lowest position, and the measurement point at which the distance is the maximum distance Distmax is not always located at a highest position. The reflectance of the object 200 is high.

As shown in FIG. 29, when the object 200 is a lane line on a road surface, the measurement point at which the distance from the light receiving unit 80 to the measurement point is the minimum distance Distmin is at the lowest position. On the other hand, the measurement point having the maximum distance Distmax is at a highest position, and the distance to the measurement point therebetween monotonically increases.

In step S610 in FIG. 27, the CPU 20 determines whether the object 200 is a thicket by using the minimum distance Distmin and the maximum distance Distmax from the light receiving unit 80 to the measurement point, an increasing tendency therebetween, and the reflectance. When neither of the following (1) and (2) is satisfied, the CPU 20 determines that the object 200 is a thicket.

(1) Road surface state condition: a distance from the light receiving unit 80 to the object 200 monotonically increases from the minimum value Distmin to the maximum value Distmax, and a difference between the maximum value Distmax and the minimum value Distmin of the distance from the light receiving unit 80 to the object 200 is larger than 0.3 m.

(2) Low reflectance or small distance difference condition: the reflectance is 60% or less, or the difference between the maximum value Distmax and the minimum value Distmin of the distance from the light receiving unit 80 to the object 200 is 0.2 m or less.

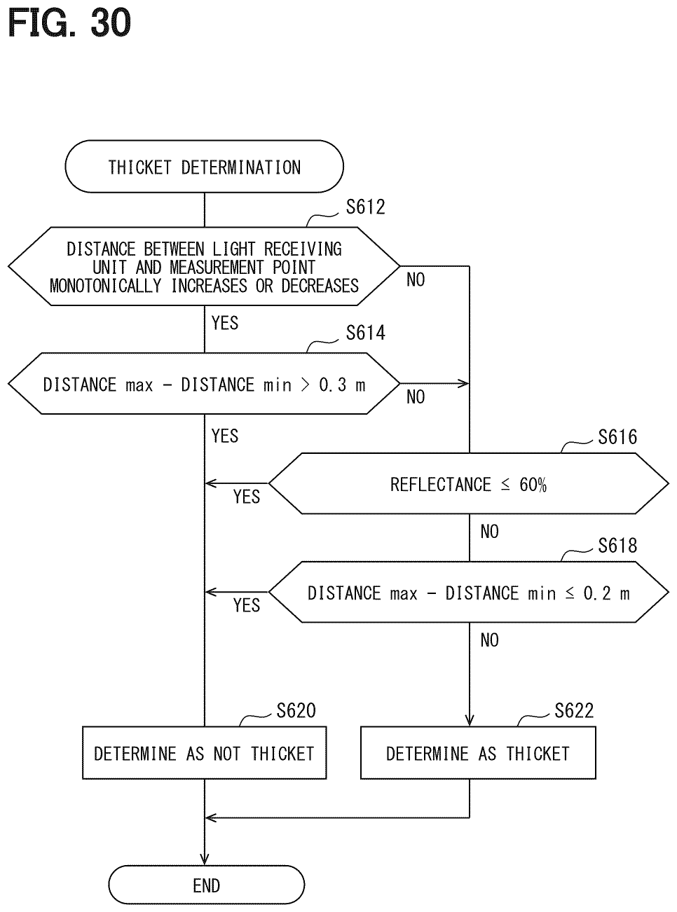

FIG. 30 is an explanatory diagram showing thicket determination (S610) performed by the CPU 20 in detail. In steps S612 and S614, the CPU 20 determines the road surface state condition in (1). In step S612, the CPU 20 determines whether the distance from the light receiving unit 80 to the object 200 monotonically increases from the minimum value Distmin to the maximum value Distmax. When the distance monotonically increases, the CPU 20 transitions the processing to step S614. On the other hand, when the distance does not monotonically increase, the processing transitions to step S616. In step S614, it is determined whether the difference between the maximum value Distmax and the minimum value Distmin of the distance from the light receiving unit 80 to the object 200 is larger than 0.3 m. When the difference between the maximum value Distmax and the minimum value Distmin of the distance is larger than 0.3 m, the processing transitions to step S620. When the difference between the maximum value Distmax and the minimum value Distmin of the distance is not larger than 0.3 m, the processing transitions to step S616. A case where steps S612 and S614 are both satisfied is a case where the road surface state condition of (1) is satisfied. The threshold of 0.3 m in step S614 is an example, and a value between 0.1 m and 0.5 m may be adopted.

In steps S616 and S618, the CPU 20 determines the low reflectance or small distance difference condition of (2). In step S616, the CPU 20 determines whether the reflectance is 60% or less. When the reflectance is 60% or less, the CPU 20 transitions the processing to step S620. On the other hand, when the reflectance exceeds 60%, the CPU 20 transitions the processing to step S618. In step S618, it is determined whether the difference between the maximum value Distmax and the minimum value Distmin of the distance is 0.2 m or less. When the difference between the maximum value Distmax and the minimum value Distmin of the distance is 0.2 m or less, the CPU 20 transitions the processing to step S620. On the other hand, when the difference between the maximum value Distmax and the minimum value Distmin of the distance exceeds 0.2 m, the CPU 20 transitions the processing to step S622. When any of the steps S616 and S618 are satisfied, the low reflectance or small distance difference condition of (2) is satisfied. Step S620 is a case where at least one of the road surface state condition of (1) and the low reflectance or small distance difference condition of (2) is satisfied. Therefore, in step S620, the CPU 20 determines that the object 200 is not a thicket. On the other hand, a case where neither of steps S616 and S618 is satisfied is a case where the road surface state condition of (1) is not satisfied and the low reflectance or small distance difference condition of (2) is not satisfied. Therefore, in step S622, the CPU 20 determines that the object 200 is a thicket. The threshold of 0.2 m in step S618 is an example, and may be any value smaller than the threshold in step S614.

In step S630, the CPU 20 performs reflectance correction. Specifically, the CPU 20 performs correction by multiplying the reflectance before correction by a correction ratio R. The correction ratio R is a value obtained by dividing a predetermined value by a distance difference between measurement points corresponding to five pixels above and below. When the distance difference is equal to or less than the predetermined distance difference, the CPU 20 does not perform the reflectance correction.

Although specific numerical values are used in the above description, the numerical values are merely examples. When an intensity of the emission light Lz, the resolution, and sensitivity of the light receiving device 82 differ, specific numerical values also differ.

### Modification:

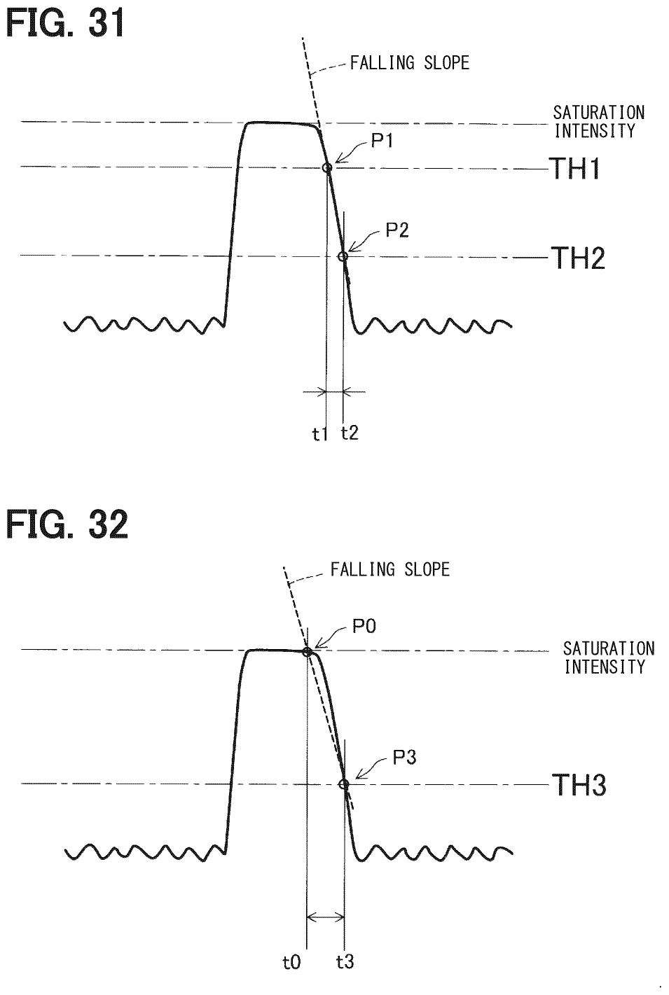

FIG. 31 is an explanatory diagram showing another method for obtaining the falling slope of the light reception signal by the falling slope detection unit 30. The falling slope detection unit 30 sets a first threshold TH1 smaller than the saturation intensity and a second threshold TH2 smaller than the first threshold TH1. When the saturation intensity is 100% and the intensity of the background light is 0%, the falling slope detection unit 30 may set the first threshold TH1 and the second threshold TH2 such that the first threshold TH1 is 80% of the saturation intensity and the second threshold TH2 is 20% of the saturation intensity. The second threshold TH2 may be the same value as the threshold used when obtaining the pulse width. The light reception signal falls to the first threshold TH1 (point P1) at a time t1 and falls to the second threshold TH2 (point P2) at a time t2 when falling. The falling slope detection unit 30 calculates the falling slope of the light reception signal, using a time t2−t1 during which the light reception signal falls from the first threshold TH1 to the second threshold TH2 and a difference between the first threshold TH1 and the second threshold TH2. According to this method, since the falling slope detection unit 30 can easily detect the time t1 and the time t2, the falling slope of the light reception signal can easily be obtained.

FIG. 32 is an explanatory diagram showing another method for obtaining the falling slope of the light reception signal by the falling slope detection unit 30. The falling slope detection unit 30 sets a third threshold TH3 smaller than the saturation intensity. The third threshold TH3 may be the same value as the threshold used when obtaining the pulse width, or may be the same value as the first threshold TH1 or the second threshold TH2 described above. The light reception signal starts falling at a time t0 (point P0) and falls to the first threshold TH3 at a time t3 (point P3). The point P at the beginning of the falling may be a point at which the intensity of the light reception signal decreases to 99% of the saturation intensity. The falling slope detection unit 30 calculates the falling slope of the light reception signal, using a time t3−t1 during which the light reception signal falls from the saturation intensity to the third threshold TH3 and a difference between the saturation intensity and the third threshold TH3. According to this method, since the falling slope detection unit 30 can easily detect the time to and the time t3, the falling slope of the light reception signal can easily be obtained.

In the above-described embodiment, when the light reception signal is saturated, the reflectance is calculated, using at least one of the pulse width and the falling slope of the light reception signal (referred to as a “saturation calculation method”), and when the light reception signal is not saturated, the reflectance is calculated based on the signal rate (referred to as a “non-saturation calculation method”). That is, the calculation method of the reflectance is different between when the light reception signal is saturated and when the light reception signal is not saturated.

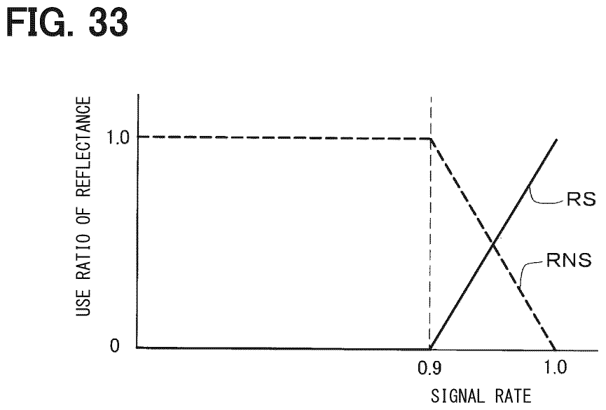

FIG. 33 is an explanatory diagram showing a method for ensuring continuity of the reflectance of the light reception signal during switching between when the light reception signal is saturated and when the light reception signal is not saturated. The reflection characteristic acquisition unit 32 calculates the saturation reflectance RS using the saturation calculation method and calculates the non-saturation reflectance RNS using the non-saturation calculation method regardless of whether the light reception signal is saturated or not saturated. Whether the light reception signal is saturated can be determined based on the signal rate. The non-saturation reflectance RNS is used as the reflectance until the signal rate reaches 0.9. When the signal rate is 1 or more, the saturation reflectance RS is used as the reflectance. When the signal rate is from 0.9 to 1, a ratio of the non-saturation reflectance RNS to the reflectance is gradually decreased and a ratio of the saturation reflectance RS is gradually increased as the signal rate increases. That is, in a region where the light reception signal transitions between a non-saturated state and a saturated state, the reflection characteristic acquisition unit 32 switches a reflectance R with a gradual change between the non-saturation reflectance RNS in the non-saturated state and the saturation reflectance RS in the saturated state. In the example shown in FIG. 33, the reflectance R can be expressed by the following equation.

$$R = ( 1 - k ) \times RNS + k \times RS ( 0 \leq k \leq 1 ) \qquad ( 4 )$$

In equation (4), the variable k indicating the ratio of the saturation reflectance RS is expressed by the following equation (5).

$$k = ( signal rate ) \times 10 - 9 ( 0.9 \leq signal rate \leq 1 ) \qquad ( 5 )$$

If the reflection characteristic acquisition unit 32 calculates the reflectance in this manner, continuity of the reflectance R can be ensured even when the non-saturation reflectance RNS and the saturation reflectance RS are not continuous during switching between when the light reception signal is saturated and when the light reception signal is not saturated. In the above-described example, as shown in equation (5), the signal rate and the variable k have a linear relationship, but the signal rate and the variable k do not necessarily have a linear relationship as long as equation (4) is satisfied.

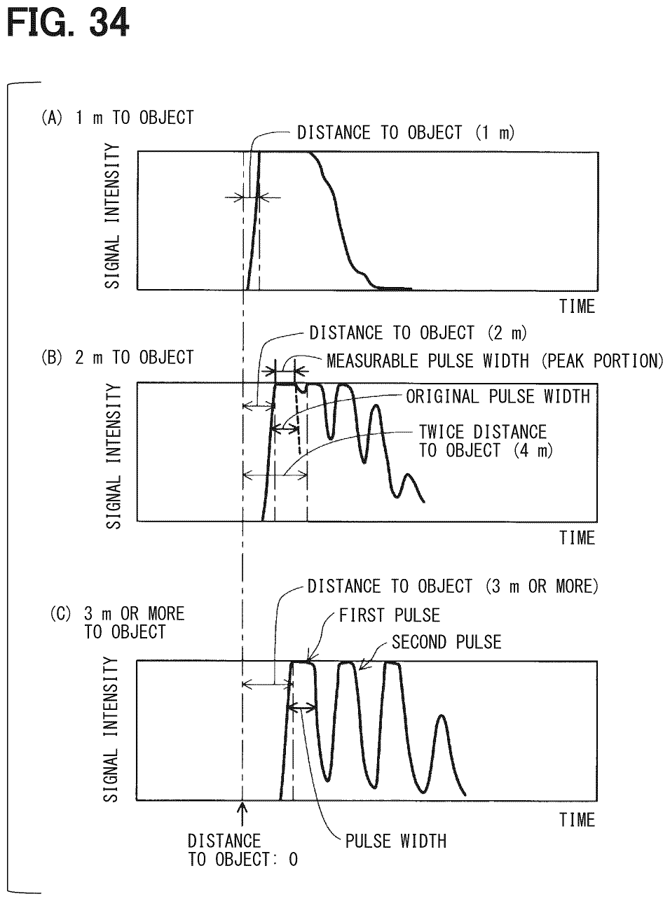

FIG. 34 is an explanatory diagram showing the signal intensity of the reflected light Rz when the reflectance of the object 200 is high. When the reflectance of the object 200 is high, the signal intensity of the reflected light Rz is also high, and thus the reflected light Rz is reflected by the object detection apparatus 10 toward the object 200. The reflected light is incident on the object 200 again and returns from the object 200. That is, the reflected light Rz is multiply reflected. The reflected light returning first is referred to as “first reflected light Rz1”, and the reflected light returning next is referred to as “second reflected light Rz2”. Depending on the reflectance of the object 200, a third reflected light Rz3, a fourth reflected light Rz4, and the like may be generated.

First, a case where the object 200 is at a distance of 3 m or more from the object detection apparatus 10 and a distance from the object detection apparatus 10 to the object 200 is large will be described. In this case, as shown in (C) in FIG. 34, a first pulse generated by the first reflected light Rz1 and a second pulse generated by the second reflected light Rz2 do not overlap and are separated, and a pulse width of the first pulse is sufficiently large. As a result, the reflection characteristic acquisition unit 32 can acquire the reflectance of the object 200, using the pulse width of the first pulse. The reflectance is an upper limit value of the reflectance.

Next, a case where the distance from the object detection apparatus 10 to the object 200 is as small as 1 m will be described. In this case, as shown in (A) in FIG. 34, the second pulse generated by the second reflected light Rz2 rises before the first pulse generated by the first reflected light Rz1 falls. As a result, the first pulse and the second pulse are combined and cannot be separated, and a pulse width of the combined pulse is sufficiently large. As a result, the reflection characteristic acquisition unit 32 can acquire the reflectance of the object 200, using the pulse width of the combined pulse. The reflectance is an upper limit value of the reflectance.

A case where the distance from the object detection apparatus 10 to the object 200 is about 2 m will be described. In this case, as shown in (B) in FIG. 34, the first pulse generated by the first reflected light Rz1 falls, and the second pulse generated by the second reflected light Rz2 rises before the first pulse falls completely. Therefore, the pulse detection unit 28 can detect only a pulse width of a peak portion having a highest signal intensity of the first pulse generated by the first reflected light Rz1. The pulse width of the peak portion is narrower than an original pulse width of the first pulse generated by the first reflected light Rz1. When the reflection characteristic acquisition unit 32 calculates the reflectance using the pulse width of the peak portion, the reflectance of the object 200 is calculated to be small. In this case, the reflection characteristic acquisition unit 32 may set the reflectance of the object 200 as an upper limit value.

From the above, when the following four conditions are satisfied, the reflection characteristic acquisition unit 32 may determine that the object 200 has a very high reflectance, such as a reflector, and set the reflectance as the upper limit value.

(a) The distance to the object 200 that reflects the emission light Lz is equal to or less than a predetermined threshold.

(b) The pulse detection unit 28 detects the first pulse corresponding to the distance to the object 200 that reflects the emission light Lz and the second pulse corresponding to twice the distance to the object 200 that reflects the emission light Lz.

(c) The signal intensity of the first pulse is equal to or larger than a predetermined threshold.

(d) A signal intensity of the second pulse is equal to or larger than a predetermined threshold.

The threshold in condition (a) is, for example, 3 m.

As described above, according to this embodiment, the reflection characteristic acquisition unit 32 can acquire the reflection characteristic of the object 200 even when the object 200 has a very high reflectance. A waveform of the detected reflected light Rz is also affected by the pulse width of the emitted emission light Lz. That is, a difference in a waveform shape is not absolute depending on the distance. Accordingly, the thresholds of the above four conditions may be appropriately determined based on the pulse width of the emission light Lz used for detection, a resolution of the light receiving unit 80, and the like. For example, in the above description, the threshold in condition (a) is set to 3 m, and may alternatively be set to another distance such as 2.5 m or 3.5 m, for example, based on the pulse width of the emission light Lz and the resolution of the light receiving unit 80.

In many cases, among the objects 200 measured using reflected waves of laser from the vehicle 100, a reflector has a highest reflectance. Therefore, when there is a reflector in the emission range S of the object detection apparatus 10, by setting the reflectance thereof as a maximum reflectance in a measurement range, the reflectance can be used for determining whether the light reception signal is saturated. In the example shown in FIG. 34, the intensity of the light reception signal is saturated, but even when there is a reflector in the emission range S, the light reception signal from the reflector may not be saturated depending on a position of the reflector in the emission range S or the like. In such a case, the reflector can still be extracted by using a method described below.

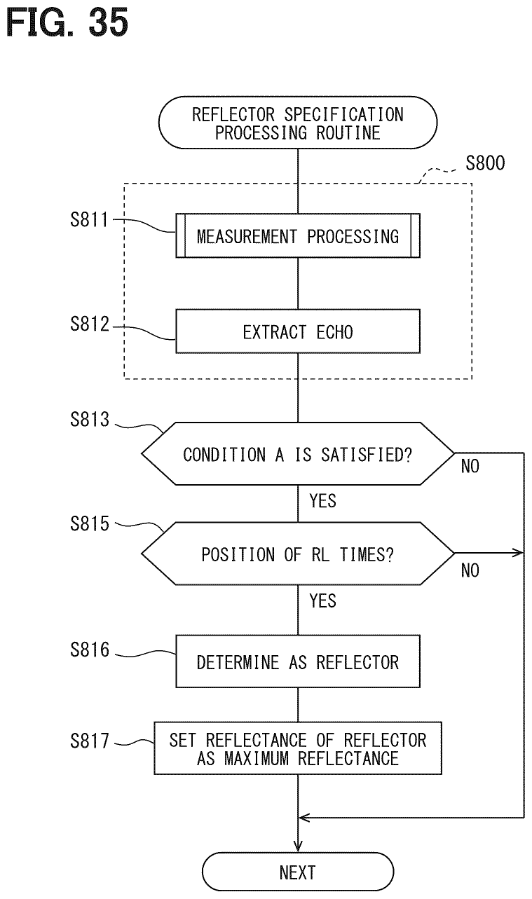

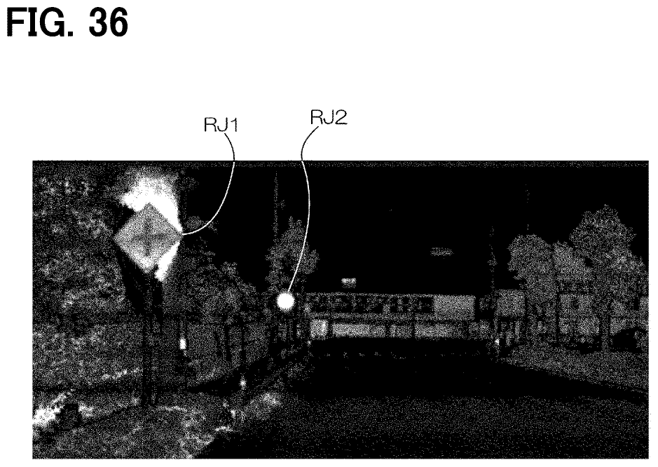

FIG. 35 is a flowchart showing a processing routine through which the reflector can be detected even when the light reception signal is not saturated. When such processing is started, as shown in the drawing, measurement processing is first performed (step S811). In the measurement processing, as described above, the laser light from the light emitting unit 70 is emitted to the emission range S, the reflected light from the emission range S is received by the light receiving unit 80, and an intensity signal over time of the reflected light with respect to the emitted laser light is acquired over the emission range S.

The emission range S is scanned, and an echo that is a signal having a peak as reflected light from a nearest position along a time axis, that is, a closest position as viewed from the object detection apparatus 10 is extracted from intensity signals acquired at respective coordinate positions (step S812). Extraction of the echo includes acquisition of a distance to an echo closest to the object detection apparatus 10. The processing of steps S811 and S812 may be collectively referred to as “echo extraction processing” as step S800.

Next, it is determined whether a condition A is satisfied for the echo thus extracted (step S813). Here, the condition A is
(i) the distance to the object 200 that reflects the emission light Lz is equal to or less than a predetermined threshold, and
(ii) the reflected light Rz is not saturated and an intensity thereof is equal to or larger than a predetermined value. If the condition A is satisfied, it is determined whether an echo is contained in the intensity signal at a position RL times (RL is an integer of 2 or more) a distance to the extracted echo (step S815). A situation in which there are multiple echoes in a signal detected at certain coordinates in the emission range S and another echo is located at a position RL times a distance to a first extracted echo does not normally occur as long as a closest echo as viewed from the object detection apparatus 10 is due to reflected light from an object. This is because, if there is an object, reflection of laser light cannot be obtained even if there is another object behind the object. As shown in a bottom part of FIG. 34, an echo is generated at a position of an integral multiple at the same coordinate position in the following case. The echo at the position of the integral multiple is generated when reflected light from a retroreflective plate such as a traffic sign is reflected by a lens or a mirror in the object detection apparatus 10 to return toward the object again, and is reflected by a reflector having a high reflectance or the like. In this case, multiple echoes are aligned at the time of a first echo, that is, at positions of integer multiples of a distance to a first object detection position.

When it is determined that there are multiple echoes at positions of RL times (step S815: “YES”), the object generating the echo is determined to be a reflector (step S816). Then, a reflectance of a portion determined to be the reflector is set as a maximum reflectance (step S817), the processing exits to “NEXT” and the present processing routine is ended. When the condition A is not satisfied (step S813: “NO”), or when the multiple echoes are not arranged at the positions of RL times (step S815: “NO”), the processing exits to “NEXT” and the present processing routine is ended. This is because the echo is not determined to be due to a reflector.

FIG. 36 shows an example of such reflector detection. In the shown example, reflected light from a round sign RJ2 at a distance among road signs located in the emission range S is saturated, and the round sign RJ2 is determined to be a reflector by the determination described with reference to FIG. 34. On the other hand, an angled sign RJ1 located closer to the vehicle 100 than the round sign RJ2 is located at an end of the emission range S when viewed from the object detection apparatus 10 mounted on the vehicle 100. Accordingly, an angle at which laser light is incident on the angled sign RJ1 is large with respect to a normal of the angled sign RJ1. Therefore, even when the angled sign RJ1 is a reflector that is a retroreflective plate, a reflected light intensity thereof is slightly low and is not saturated. However, since the condition A and the condition that there are multiple echoes at the positions of RL times are satisfied, even though the signal intensity is not saturated, it can be determined that the angled sign RJ1 is a reflector.

In the example shown in FIG. 36, since a signal intensity of the reflected light from the distant round sign RJ2 is saturated, a reflectance of the reflected light from the round sign RJ2 can be handled as a maximum reflectance. However, when the round sign RJ2 is absent, there is no object whose signal intensity is saturated, and thus the maximum reflectance cannot be set. In this regard, if the determination is performed by the method shown in FIG. 36, since the reflector can be detected, a signal intensity of reflected light from the reflector can be set as the maximum reflectance in the emission range S. Therefore, it is possible to easily distinguish another object based on the maximum reflectance.

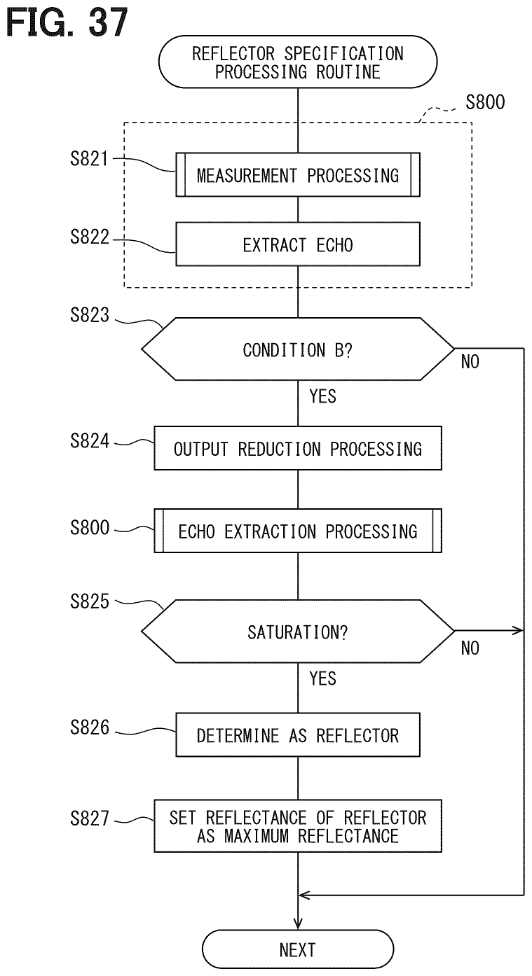

Still another example of the reflector detection and the setting of the maximum reflectance is shown in FIG. 37. Steps S821 and S822 in shown processing are the same as processing contents of the echo extraction processing (step S800) shown in FIG. 35, and the echo is extracted at each coordinate in the emission range S. In this example, subsequently, it is determined whether a condition B is satisfied (step S823). The condition B in this case is
(i) the distance to the object 200 that reflects the emission light Lz is equal to or less than a predetermined threshold, and
(iia) the signal intensity of the reflected light Rz is saturated. If the condition B is satisfied, processing of reducing an output intensity of laser light in the light emitting unit 70 is performed next (step S824). Thereafter, the echo extraction processing (step S800) is performed again for the same coordinate position to determine whether the signal intensity of the reflected light is saturated (step S825). If the reflection light is saturated, it is determined that a target whose reflection light is detected is a reflector (step S826), a reflectance of a portion determined to be the reflector is set as the maximum reflectance (step S827), then the processing exits to “NEXT” and the present processing routine is ended. When the condition B is not satisfied (step S813: “NO”), when a signal intensity of the echo is not saturated (step S825: “NO”), or the like, it is not determined that the echo is due to a reflector, the processing exits to “NEXT”, and the present processing routine is ended.

In this example, without considering the condition that there is an echo at the same coordinate position at a position of an integral multiple on the time axis, it is determined whether the object 200 is a reflector under conditions that
(i) the distance to the object 200 that reflects the emission light Lz is equal to or less than a predetermined threshold,
(iia) the signal intensity of the reflected light Rz is saturated, and
(iii) the signal intensity of the reflected light Rz remains saturated even when output of the emission light Lz is reduced. This is because, when the signal intensity of the reflected light is saturated, an object whose reflected light signal intensity is saturated even when the intensity of the light emitted by the light emitting unit 70 is reduced (step S824) can be determined as a reflector that returns reflected light in a specific direction, such as a retroreflective plate. According to this method, in order to determine whether the object 200 at a specific coordinate is a reflector, it is not necessary to check whether there is any echo located or arranged at the position of RL times on the time axis, and the processing can be simplified.

In the above-described processing, the output reduction processing (step S824) is performed by reducing an intensity of the emission light Lz by the light emitting unit 70, and the output reduction processing may alternatively be performed by another method. For example, the output reduction processing may also be implemented by widening a range where the object detection apparatus 10 reads a signal from the light receiving unit 80, that is, the detection target region ROI of the echo. In the present embodiment, the processing of widening the detection target region ROI is performed by widening a range where the light reception signal is read from the light receiving unit 80 of the object detection apparatus 10. The processing of widening the detection target region ROI may also be implemented by directly controlling the light emitting unit 70 including the scanner 74 and the light receiving unit 80 by hardware.

### B. Second Embodiment

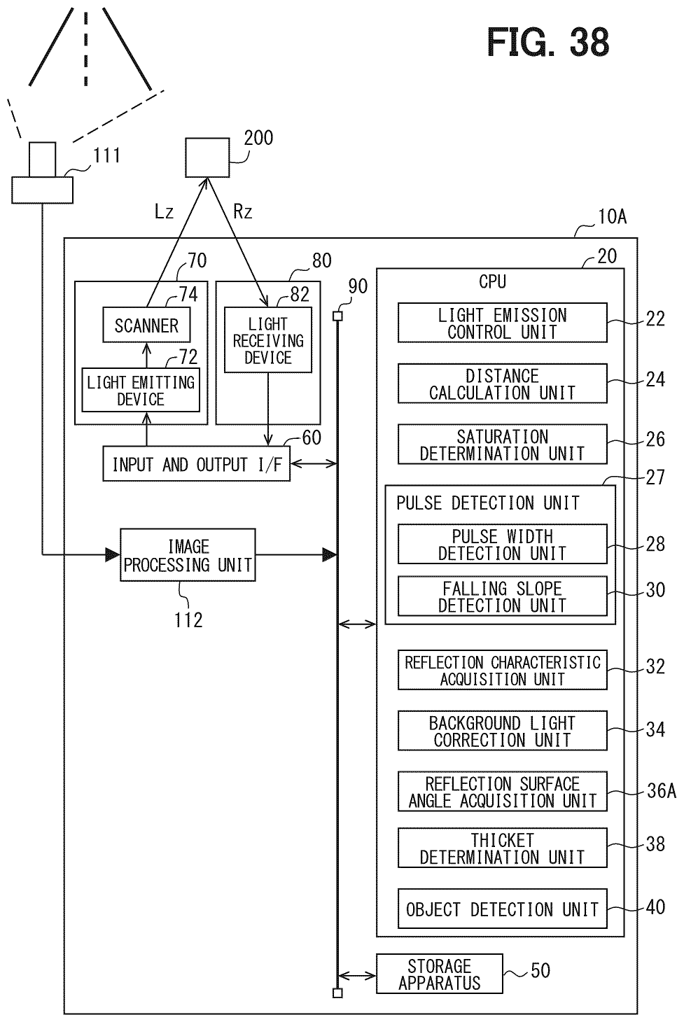

Next, processing performed by an object detection apparatus 10A according to a second embodiment will be described. FIG. 38 is a block diagram showing a schematic configuration of the object detection apparatus 10A according to the second embodiment mounted on the vehicle 100. The object detection apparatus 10A is different from the object detection apparatus 10 according to the first embodiment in that a video camera 111 and an image processing unit 112 that imports and processes a video signal from the video camera 111 are provided. Other hardware configurations of the second embodiment are the same as those in the first embodiment. The program executed by the CPU 20 and functions implemented by the execution of the program are the same as those in the first embodiment except for a reflection surface angle acquisition unit 36A.

The video camera 111 is provided at a front surface of the vehicle 100, captures a video of a range including the emission range S scanned by the object detection apparatus 10A, and outputs the video to the image processing unit 112. The image processing unit 112 is capable of analyzing the video captured by the video camera 111 and extracting a lane line or a road shoulder in an image. A technique for extracting a road shoulder of a road where the vehicle travels, a lane line indicating a traveling lane, and the like from the video captured by the video camera 111 is a known technique, and detailed description thereof will be omitted (for example, see JP2004-21723A). The image processing unit 112 outputs such a processing result of detection of the road shoulder and the lane line to the CPU 20, and supplies the processing result for processing of the reflection surface angle acquisition unit 36A.

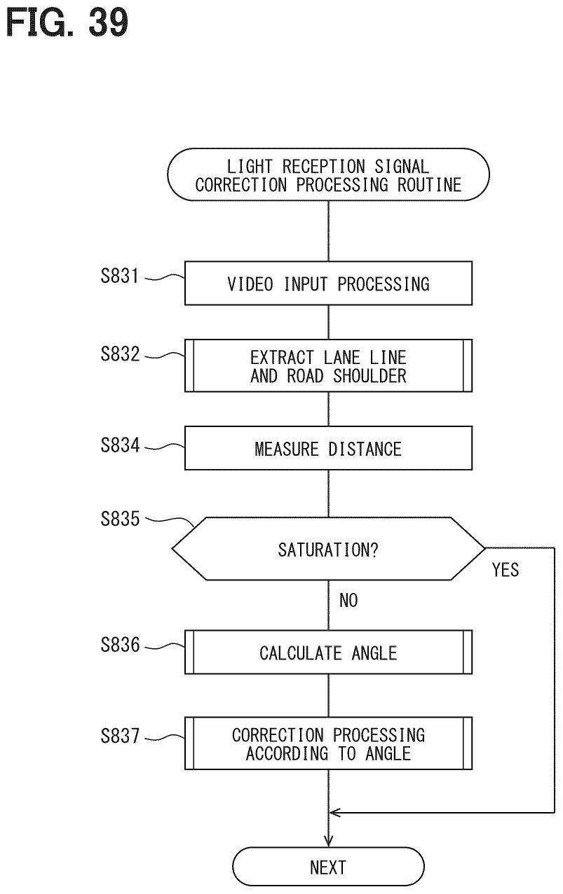

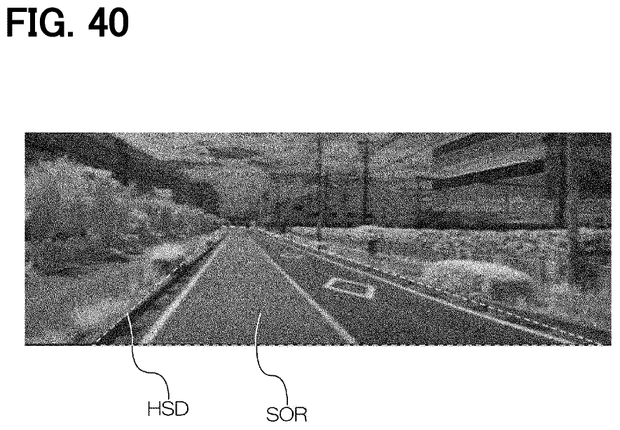

The CPU 20 performs the processing shown in FIG. 39. Such processing corresponds to the processing in step S540 in FIG. 22 in the first embodiment described above. When the processing is started, first, a video signal from the video camera 111 is input, using the image processing unit 112 (step S831), and road shoulder and lane line extraction processing is performed based on an image in the input video signal (step S832). Since the road shoulder and lane line extraction processing is a known method as described above, detailed description thereof will be omitted. An example of extracting the road shoulder and the lane line from the image is shown in FIG. 40. In this example, a detected road shoulder HSD is indicated by a broken line.

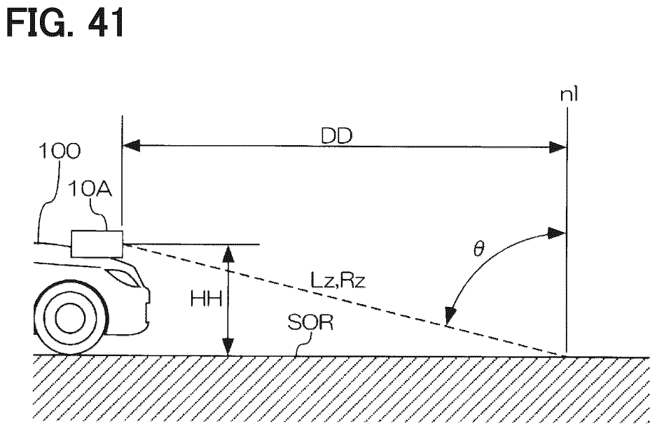

Next, a distance is measured using the extracted road shoulder or lane line as a target object (step S834). A distance DD to the target object can be specified using a function of the object detection apparatus 10A. Then, it is determined whether the signal intensity of the reflected light is saturated using the light emitting unit 70 and the light receiving unit 80 of the object detection apparatus 10A (step S835). When it is determined that the reflected light is not saturated, a reflection surface angle, which is an angle at each position of the target object, is calculated, using a measurement result of the distance to the target object whose reflected light is detected (step S836). If the distance to each position of the target object is known, it is easy to know the reflection surface angle θ that is an angle of the emission light Lz with respect to a normal nl at a specific position on the target object based on a position (height HH) where the light receiving unit 80 and the like are provided. This state is shown in FIG. 41. Here, the road shoulder and the lane line are regarded as being located on a road surface SOR, and the reflection surface angle θ is obtained as

θ=90−tan(HH/DD).

Then, processing of correcting the non-saturation reflectance is performed according to the reflection surface angle θ (step S837). Such correction processing is the same as that described with reference to FIG. 26 in the first embodiment. The correction processing may be performed only when the reflection surface angle θ is a predetermined angle, for example, 45 degrees or more. This is because, when the reflection surface angle θ is small, the distance to the target object is relatively short, the emission light Lz is close to a normal of a surface of the target object, and thus the signal intensity of the reflected light Rz is originally high. After such correction processing according to the reflection surface angle θ is performed, the processing exits to “NEXT”, and the present processing routine is ended.

As long as the processing described above is performed, the road shoulder and the lane line are specified based on the image captured by the video camera 111, then the reflectance is corrected, thus processing for obtaining a reflectance of the road surface can be simplified, and an amount of calculation for obtaining the reflectance can be reduced. The same procedure can be applied to a case of obtaining a reflectance of, for example, a long wall or a guard rail on a road side. Although the reflectance is corrected in the above-described processing, the reflection intensity may be corrected when the processing is performed using the reflection intensity.

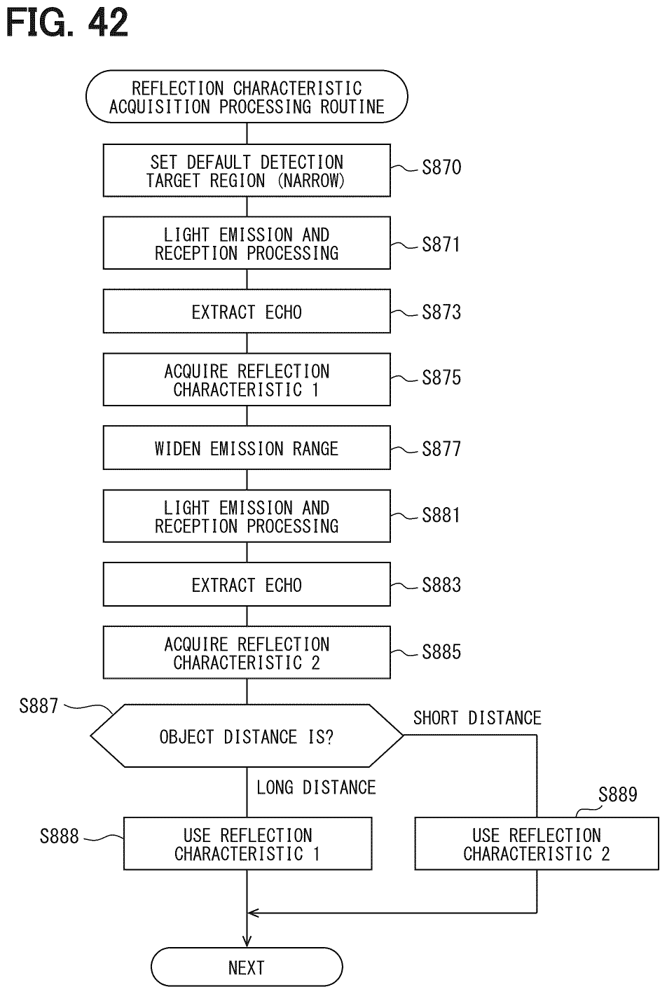

Next, reflection characteristic acquisition processing will be described with reference to FIG. 42. The shown processing is repeatedly performed at a predetermined interval, for example, every 100 msec. In such processing, a reflection characteristic used in the processing, specifically, the reflectance or the reflection intensity is varied by switching a width of the detection target region ROI, and a characteristic according to a purpose and a condition of the processing is used. In the reflection characteristic acquisition processing started every predetermined time, first, processing of setting the detection target region ROI, which is a range read from the emission range S by the light receiving unit 80, to a narrow range in default is performed (step S870).

Next, light emission processing using the light emitting unit 70 and light reception processing using the light receiving unit 80 are performed (step S871), and an echo is extracted based on a received signal (step S873). Then, a reflection characteristic 1 is acquired from the echo (step S875). The reflection characteristic 1 is the reflectance or the reflection intensity. In the following description, the reflectance will be described, and the reflection intensity may be used or the reflectance and the reflection intensity may both be used.

Next, processing of widening the detection target region ROI that is the range read from the emission range S by the light receiving unit 80 is performed (step S877). The detection target region ROI is a narrow region in default, and thus is switched to a wide region with the emission range S serving as a maximum range. After the detection target region ROI is widened, the light emission processing using the light emitting unit 70 and the light reception processing using the light receiving unit 80 are performed as in steps S871 to S875 (step S881). Thereafter, an echo is extracted based on the received signal (step S883), and a reflection characteristic 2 is acquired from the echo (step S885).

By the above-described processing, the reflection characteristic 1 in a state in which the detection target region ROI is narrowed and the reflection characteristic 2 in a state in which the detection target region ROI is widened are stored in the storage apparatus 50. Since the reflection characteristic 2 is acquired in the state in which the detection target region ROI is widened, a dynamic range is wider than that of the reflection characteristic 1 acquired in the state in which the detection target region ROI is narrow, and thus the signal intensity of the reflected light is unlikely to be saturated. Therefore, the distance to the object 200 returning the reflected light is determined based on a value of the extracted echo on the time axis (step S887), and it is set whether to use the reflection characteristic 1 or the reflection characteristic 2 according to the distance. Specifically, when the distance to the object 200 is a “long distance” larger than a predetermined threshold, the reflection characteristic 1 is used (step S888). On the other hand, when the distance to the object 200 is a “short distance” equal to or less than the predetermined threshold, the reflection characteristic 2 is used (step S889). After the above-described processing, the processing exits to “NEXT” and the present processing routine is ended.

By repeatedly executing the reflection characteristic acquisition processing routine described above, the object detection apparatus 10A constantly stores, in the storage apparatus 50, the reflection characteristic 1 and the reflection characteristic 2 acquired in the state in which the width of the detection target region ROI is switched. Therefore, according to the distance to the object 200 determined based on the echo, the reflection characteristic obtained in the state in which the reflected light is unlikely to be saturated can be used. If the detection target region ROI is widened, the reflected light is normally in the state of being unlikely to be saturated, the dynamic range is large, and a signal from an object at a long distance becomes weak. In this regard, by performing the above-described processing, the detection target region ROI can be narrowed for the object at the long distance, and the processing can be performed while the intensity signal of the reflected light is intensified. When measurement is performed by narrowing the detection target region ROI, the intensity signal is easily saturated, and since the reflected light is originally from a long distance, the signal intensity of the reflected light is weak, and a possibility of saturation is low. Therefore, in processing using the reflectance or the like, there is a high possibility that the method in the case where the intensity signal is saturated, that is, the processing of calculating the saturation reflectance based on the pulse width and the falling slope shown in step S520 in FIG. 22 can be avoided. On the other hand, when the measurement is performed by widening the detection target region ROI, the intensity signal is less likely to be saturated, thus the possibility of saturation is reduced even when the reflected light is from a short distance and has a strong signal intensity. Therefore, in the processing using the reflectance or the like, there is a high possibility that the non-saturation method used when the intensity signal is not saturated, that is, the processing of calculating the non-saturation reflectance based on the signal rate (signal intensity) shown in step S530 in FIG. 22 is performed. As a result, the processing of calculating the reflectance can be simplified, and a variation in a calculation result of the reflectance can be reduced. Although the reflectance is used in the above-described processing, the same also applies to a case where the reflection intensity is used as the reflection characteristic. In the above-described processing, the width of the detection target region ROI is switched to make it difficult for the signal intensity of the reflected light to be saturated, and the same effect can be obtained by dynamically switching a light emission intensity of the light emitting unit 70.

### C. Other Embodiments

(1) According to an aspect of the present disclosure, the object detection apparatus 10 is provided. The object detection apparatus 10 includes: the light emitting unit 70 that emits the emission light Lz toward the predetermined emission range S; the light receiving unit 80 that receives the reflected light Rz corresponding to the emission light Lz; the distance calculation unit 24 that calculates a distance to the object 200 that reflects the emission light Lz, using a time from emission of the emission light Lz to reception of the reflected light Rz; the saturation determination unit 26 that determines whether a light reception signal corresponding to the reflected light Rz output from the light receiving unit 80 is saturated; the pulse width detection unit 28 that detects a pulse width at a predetermined threshold of the light reception signal; a falling slope detection unit 30 that detects a falling slope of the light reception signal; and the reflection characteristic acquisition unit 32 that acquires a reflection characteristic including at least one of a reflection intensity and a reflectance of the object 200. When the light reception signal is saturated, the reflection characteristic acquisition unit 32 acquires the reflection characteristic using at least one of the pulse width and the falling slope. According to the object detection apparatus 10 in this aspect, it is possible to detect a difference in an intensity (signal intensity) of the reflected light of the object 200 even when an intensity of the light reception signal is in a saturated region of the light receiving unit 80.

(2) The object detection apparatus 10 according to the aspect (1) described above may further include the object detection unit 40 that detects the object 200, using the reflection characteristic and a distance to the reflection point RP of the emission light on the object 200. According to this aspect, it is possible to detect what the object 200 is.

(3) In the object detection apparatus 10 according to the aspect (1) or (2) described above, the falling slope may be a rate of change over time of the light reception signal between the peak point PP at which the light reception signal reaches a saturation intensity and the end point EP at which the light reception signal falls to the threshold. According to the object detection apparatus 10 in this aspect, it is possible to easily calculate the falling slope of the light reception signal.

(4) In the object detection apparatus 10 according to the above-described aspects, the falling slope detection unit 30 may set the first threshold TH1 smaller than the saturation intensity and the second threshold TH2 smaller than the first threshold, and may calculate the falling slope, using a time until the light reception signal falls from the first threshold to the second threshold and a difference between the first threshold and the second threshold. According to the object detection apparatus 10 in this aspect, it is possible to easily calculate the falling slope of the light reception signal.

(5) In the object detection apparatus 10 according to the above-described aspects, the falling slope detection unit 30 may set the third threshold TH3 smaller than the saturation intensity, and may calculate the falling slope, using a time until the light reception signal falls to the third threshold TH3 from a time when the light reception signal falls from the saturation intensity and a difference between the saturation intensity and the third threshold TH3. According to the object detection apparatus 10 in this aspect, it is possible to easily calculate the falling slope of the light reception signal.

(6) In the object detection apparatus 10 according to the aspects (1) to (5) described above, the reflection characteristic acquisition unit 32 may acquire the reflection characteristic after averaging the pulse width and the falling slope. According to the object detection apparatus 10 in this aspect, it is possible to reduce an influence of a variation in the pulse width and the falling slope.

(7) In the object detection apparatus 10 according to any one of the aspects (1) to (6) described above, when the light reception signal is not saturated, the reflection characteristic acquisition unit 32 may acquire the reflection characteristic using at least one of the intensity and the pulse width of the light reception signal. According to the object detection apparatus 10 in this aspect, when the light reception signal is not saturated, the intensity and the pulse width of the light reception signal can be easily measured, and the reflection characteristic can be easily obtained based on the intensity of the light reception signal.

(8) In the object detection apparatus 10 according to the above-described aspects, when the light reception signal is not saturated, the reflection characteristic acquisition unit 32 may acquire the reflection characteristic using a signal rate that is an intensity ratio of a difference between the intensity of the light reception signal and an intensity of background light to a difference between a saturation intensity of the light reception signal and the intensity of the background light. According to the object detection apparatus 10 in this aspect, the reflection characteristic of the object 200 can be acquired while an influence of the background light is removed.

(9) In the object detection apparatus 10 according to the above-described aspects, the reflection characteristic acquisition unit 32 may switch, in a region where the light reception signal transitions between a non-saturated state and a saturated state, the reflection characteristic with a gradual change between the reflection characteristic in the non-saturated state and the reflection characteristic in the saturated state. According to the object detection apparatus 10 in this aspect, continuity of the reflection characteristic in the non-saturated state and the saturated region can be ensured.

(10) In the object detection apparatus 10 according to the above-described aspects, the reflection characteristic acquisition unit 32 may acquire the reflection characteristic after averaging the intensity of the light reception signal. According to the object detection apparatus 10 in this aspect, it is possible to reduce an influence of a variation in the intensity of the light reception signal.

(11) In the object detection apparatus 10 according to the aspects (1) to (10) described above, the reflection characteristic may be one of the reflection intensity and the reflectance of the object 200.

(12) The object detection apparatus 10 according to the aspects (1) to (11) described above may further include a background light correction unit 34 that performs correction to remove an influence of background light from the light reception signal. The reflection characteristic acquisition unit 32 may acquire the reflection characteristic after the background light correction unit 34 performs the correction to remove the influence of the background light from the light reception signal. The intensity of the background light differs between daytime and nighttime, and the intensity of the light reception signal differs. According to the object detection apparatus 10 in this aspect, the reflection characteristic of the object 200 can be acquired while an influence of the background light is removed.

(13) In the object detection apparatus 10 according to the aspects described above, the background light correction unit 34 may remove, when the light reception signal is saturated, the influence of the background light on the pulse width and the falling slope, and may remove, when the light reception signal is not saturated, the influence of the background light on at least one of the intensity and the pulse width of the light reception signal.

(14) The object detection apparatus 10 according to the aspects (1) to (13) described above may further include the reflection surface angle acquisition unit 36 that acquires, as the reflection surface angle θ, an angle formed by a direction of the object 200 and a normal of a reflection surface of the object 200. The reflection characteristic acquisition unit 32 may correct the reflection characteristic, using the reflection surface angle θ. An intensity of a component of the reflected light returning in a direction of the light receiving unit 80 differs depending on an angle (reflection surface angle θ) at which the emission light is incident on the surface of the object 200. According to the object detection apparatus 10 in this aspect, the reflection characteristic of the object 200 can be acquired while an influence of the reflection surface angle from the light reception signal is removed.

(15) In the object detection apparatus 10 according to the aspects described above, the reflection characteristic acquisition unit 32 may perform, when the light reception signal is not saturated, correction to increase the intensity of the light reception signal as the reflection surface angle θ increases, and may perform, when the light reception signal is saturated, correction to decrease the intensity of the light reception signal as the reflection surface angle increases. According to the object detection apparatus 10 in this aspect, the influence of the reflection surface angle θ on the light reception signal can be removed.

(16) In the object detection apparatus 10 according to the aspects described above, the reflection surface angle acquisition unit 36 may acquire the reflection surface angle θ, using at least one of a direction vector between two proximity points NP interposing the reflection point RP on the object 200 from above and below, and a direction vector between two proximity points NP interposing the reflection point RP on the object 200 from left and right, and a sensor vector indicating a direction from the reflection point RP to the light receiving unit 80.

(17) The object detection apparatus 10 according to the aspects described above may further include the thicket determination unit 38 that determines whether the reflection point RP is in a thicket, using a distance from the light receiving unit 80 to the reflection point RP and the adjacent reflection point ARP in the vicinity of the reflection point RP and a variation in the reflection characteristic. When the reflection point RP is in the thicket, the reflection characteristic acquisition unit 32 may correct the reflection characteristic downward according to a variation in the distance from the light receiving unit 80 to the reflection point RP and the adjacent reflection point ARP. A thicket has a high reflectance. According to the object detection apparatus 10 in this aspect, the reflection characteristic can be corrected downward when the object is a thicket.

(18) In the object detection apparatus 10 according to the aspects (1) to (17) described above, the distance to the object 200 that reflects the emission light Lz may be equal to or less than a predetermined threshold, the pulse detection unit 28 may detect a first pulse corresponding to the distance to the object 200 that reflects the emission light Lz and a second pulse corresponding to twice the distance to the object 200 that reflects the emission light. When a signal intensity of the first pulse is equal to or larger than a predetermined threshold and a signal intensity of the second pulse is equal to or larger than a predetermined threshold, the reflection characteristic acquisition unit may acquire the reflectance as a predetermined upper limit value. According to this aspect, the reflection characteristic acquisition unit 32 can acquire the reflection characteristic of the object 200 even when the reflectance of the object 200 is large and multiple reflection occurs.

(19) The object detection apparatus according to the aspects (1) to (18) described above may further include a reflector detection unit that determines, based on a first light reception signal corresponding to the distance to the object that reflects the emission light and a second light reception signal corresponding to a distance RL times (RL is an integer of 2 or more) the distance to the object obtained based on the first light reception signal at a predetermined position on the light receiving unit, that the object at a position corresponding to the first light reception signal is a reflector. In this way, when the detected object is a reflector, such a fact can be easily determined.

(20) The object detection apparatus according to the aspects (1) to (19) described above may further include a reduction unit that reduces at least one of the intensity of the reflected light and detection sensitivity of the light reception signal corresponding to the reflected light; and a reflector detection unit that reduces, when the saturation determination unit determines that the light reception signal corresponding to the distance to the object that reflects the emission light is saturated, at least one of the intensity of the reflected light and the detection sensitivity of the light reception signal corresponding to the reflected light, and determines, when the light reception signal remains saturated even after the reduction, that the object at a position corresponding to the light reception signal is a reflector. In this case, when the detected object is a reflector, such a fact can still be easily determined. Various configurations such as a configuration in which output of the light emitting unit is reduced, a configuration in which light reception sensitivity of the light receiving unit is reduced, and a configuration in which the detection target region of the emission light is widened can be adopted for the reduction unit. Of course, these configurations may be implemented in a combined manner.

(21) The object detection apparatus according to the aspects (1) to (20) described above may further include a reflection surface angle analysis unit that analyzes a position of the detected object or the light reception signal on the object for at least a part in a region where the object detection apparatus detects the object, and analyzes a reflection surface angle that is an angle formed by a direction of the object and a normal of a reflection surface of the object; and a correction unit that corrects, when the light reception signal is not saturated and the analyzed reflection surface angle is larger than a predetermined angle threshold, at least one of the reflection intensity and the reflectance of the object in the reflection characteristic acquisition unit to a value larger than that when the reflection surface angle is equal to or less than the angle threshold. In this way, it is possible to easily specify a road surface, a lane line, and the like. The analysis of the position of the object for analyzing the reflection surface angle may be performed based on an image captured by an imaging apparatus such as a camera.

(22) The object detection apparatus according to the aspects (1) to (21) described above may further include a reduction unit that reduces, when the saturation determination unit determines that the light reception signal corresponding to the distance to the object that reflects the emission light is saturated, at least one of the intensity of the reflected light and the detection sensitivity of the light reception signal corresponding to the reflected light to mitigate a saturation level of the light reception signal. In this way, the saturation level of the light reception signal can be reduced, and a variation in calculation of the reflection characteristic can be reduced. Various configurations such as a configuration in which output of the light emitting unit is reduced, a configuration in which light reception sensitivity of the light receiving unit is reduced, and a configuration in which the detection target region of the emission light is widened can be adopted for the reduction unit. Of course, these configurations may be implemented in a combined manner.

(23) In the object detection apparatus according to the aspects described above, the reduction unit may change the detection sensitivity of the light reception signal corresponding to the reflected light by switching a detection target region, which is a distance detection target region, in at least two stages, and may cause the reflection characteristic acquisition unit to acquire the reflection characteristic on a higher accuracy side by the switching. In this way, the object can be detected with high accuracy only by switching the detection target region. If the switching is dynamically performed, highly accurate detection can be performed at any time.

(24) According to another aspect of the present disclosure, an object detection method of the object detection apparatus 10 is provided. The object detection method includes: emitting the emission light Lz toward the predetermined emission range S; receiving the reflected light Rz corresponding to the emission light Lz; calculating a distance to the object 200 that reflects the emission light Lz, using a time from emission of the emission light Lz to reception of the reflected light Rz; determining whether a light reception signal corresponding to the reflected light Rz is saturated; detecting a pulse width of the light reception signal at a predetermined threshold; detecting a falling slope of the light reception signal; and calculating a reflection characteristic using at least one of the pulse width and the falling slope when the light reception signal is saturated. According to the object detection method in this aspect, even when the signal intensity obtained from reflected light Rz is in a saturated region of the light receiving unit 80 that receives the reflected light Rz, it is possible to detect a difference in the intensity (signal intensity) of the reflected light of the object 200.

(25) The object detection method according to the aspect described above may further include acquiring, when the light reception signal is not saturated, the reflection characteristic using an intensity of the light reception signal. According to the object detection method in this aspect, when the light reception signal is not saturated, the intensity of the light reception signal can be easily measured, and the reflection characteristic can be easily obtained based on the intensity of the light reception signal.

The control unit and the method described in the present disclosure may be implemented by a dedicated computer provided by forming a processor and a memory programmed to execute one or multiple functions embodied by a computer program. Alternatively, the control unit and the method described in the present disclosure may be implemented by a dedicated computer provided by forming a processor with one or more dedicated hardware logic circuits. Alternatively, the control unit and the method described in the present disclosure may be implemented by one or more dedicated computers including a combination of a processor and a memory programmed to execute one or multiple functions and a processor including one or more hardware logic circuits. The computer program may be stored in a computer-readable non-transitory tangible recording medium as an instruction to be executed by a computer.

The present disclosure is not limited to the above-described embodiments, and can be implemented by various configurations without departing from the gist of the present disclosure. For example, the technical features in the embodiments corresponding to the technical features in the aspects described in the summary of the invention can be replaced or combined as appropriate in order to solve a part or all of the above-described problems or in order to achieve a part or all of the above-described effects. In addition, unless the technical features are described as being essential in the present specification, the technical features may be appropriately deleted.

The present disclosure may be implemented by way of methods as follows.

An object detection method for an object detection apparatus using light, the object detection method comprising:
emitting emission light toward a predetermined emission range;
receiving reflected light corresponding to the emission light;
calculating a distance to an object that reflects the emission light, using a time from emission of the emission light to reception of the reflected light;
determining whether a light reception signal corresponding to the reflected light is saturated;
detecting a pulse width of the light reception signal at a predetermined threshold;
detecting a falling slope of the light reception signal;
calculating a reflection characteristic using at least one of the pulse width or the falling slope when the light reception signal is saturated;
acquiring, when the light reception signal is not saturated, the reflection characteristic using an intensity of the light reception signal; and
switching, in a region where the light reception signal transitions between a non-saturated state and a saturated state, the reflection characteristic with a gradual change between the reflection characteristic in the non-saturated state and the reflection characteristic in the saturated state.

An object detection method for an object detection apparatus using light, the object detection method comprising:
emitting emission light toward a predetermined emission range;
receiving reflected light corresponding to the emission light;
calculating a distance to an object that reflects the emission light, using a time from emission of the emission light to reception of the reflected light;
determining whether a light reception signal corresponding to the reflected light is saturated;
detecting a pulse width of the light reception signal at a predetermined threshold;
detecting a falling slope of the light reception signal; and
after averaging the intensity of the light reception signal,
   calculating, when the light reception signal is saturated, a reflection characteristic using at least one of the pulse width or the falling slope, and
   acquiring, when the light reception signal is not saturated, the reflection characteristic using the intensity of the light reception signal.

An object detection method for an object detection apparatus using light, the object detection method comprising:
emitting emission light toward a predetermined emission range;
receiving reflected light corresponding to the emission light;
calculating a distance to an object that reflects the emission light, using a time from emission of the emission light to reception of the reflected light;
determining whether a light reception signal corresponding to the reflected light is saturated;
detecting a pulse width of the light reception signal at a predetermined threshold;
detecting a falling slope of the light reception signal;
calculating a reflection characteristic using at least one of the pulse width or the falling slope when the light reception signal is saturated;
acquiring, as a reflection surface angle, an angle formed by a direction of the object and a normal of a reflection surface of the object; and
correcting the calculated reflection characteristic using the reflection surface angle.

An object detection method for an object detection apparatus using light, the object detection method comprising:
emitting emission light toward a predetermined emission range;
receiving reflected light corresponding to the emission light;
calculating a distance to an object that reflects the emission light, using a time from emission of the emission light to reception of the reflected light;
determining whether a light reception signal corresponding to the reflected light is saturated;
detecting a pulse width of the light reception signal at a predetermined threshold;
detecting a falling slope of the light reception signal;
calculating a reflection characteristic using at least one of the pulse width or the falling slope when the light reception signal is saturated;
analyzing a position of the detected object or the light reception signal on the object for at least a part in a region where the object is detected;
analyzing a reflection surface angle that is an angle formed by a direction of the object and a normal of a reflection surface of the object; and
correcting, when the light reception signal is not saturated and when the analyzed reflection surface angle is larger than a predetermined angle threshold, at least one of the reflection intensity or the reflectance of the object to a value larger than that when the reflection surface angle is equal to or less than the angle threshold, when calculating the reflection characteristic.

An object detection method for an object detection apparatus using light, the object detection method comprising:
emitting emission light toward a predetermined emission range;
receiving reflected light corresponding to the emission light;
calculating a distance to an object that reflects the emission light, using a time from emission of the emission light to reception of the reflected light;
determining whether a light reception signal corresponding to the reflected light is saturated;
detecting a pulse width of the light reception signal at a predetermined threshold;
detecting a falling slope of the light reception signal;
calculating a reflection characteristic using at least one of the pulse width or the falling slope when the light reception signal is saturated;
when determining that the light reception signal corresponding to the distance to the object that reflects the emission light is saturated, switching the emission range in at least two stages to mitigate a saturation level of the light reception signal corresponding the reflected light, and to switch a detection sensitivity of the light reception signal corresponding to the reflected light; and
when calculating the reflection characteristic, switching the emission range to acquire the reflection characteristic having a higher accuracy.

What is claimed is:

1. An object detection apparatus configured to detect an object by reflected light from the object, the object detection apparatus comprising:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal; and
a reflection characteristic acquisition unit configured to acquire a reflection characteristic including at least one of a reflection intensity or a reflectance of the object, wherein
the reflection characteristic acquisition unit is configured to
acquire the reflection characteristic using at least one of the pulse width or the falling slope, when the light reception signal is saturated,
acquire the reflection characteristic using at least one of an intensity or the pulse width of the light reception signal, when the light reception signal is not saturated, and
switch, in a region where the light reception signal transitions between a non-saturated state and a saturated state, the reflection characteristic with a gradual change between the reflection characteristic in the non-saturated state and the reflection characteristic in the saturated state.

2. The object detection apparatus according to claim 1, further comprising:
an object detection unit configured to detect the object, using the reflection characteristic and a distance to a reflection point of the emission light on the object.

3. An object detection apparatus configured to detect an object by reflected light from the object, the object detection apparatus comprising:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal; and
a reflection characteristic acquisition unit configured to acquire a reflection characteristic including at least one of a reflection intensity or a reflectance of the object, wherein
the reflection characteristic acquisition unit is configured to, after averaging the intensity of the light reception signal,
acquire the reflection characteristic using at least one of the pulse width or the falling slope, when the light reception signal is saturated, and
acquire the reflection characteristic using at least one of the intensity or the pulse width of the light reception signal, when the light reception signal is not saturated.

4. The object detection apparatus according to claim 3, further comprising:
an object detection unit configured to detect the object, using the reflection characteristic and a distance to a reflection point of the emission light on the object.

5. An object detection apparatus configured to detect an object by reflected light from the object, the object detection apparatus comprising:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal;
a reflection characteristic acquisition unit configured to acquire a reflection characteristic including at least one of a reflection intensity or a reflectance of the object; and
a reflection surface angle acquisition unit configured to acquire, as a reflection surface angle, an angle formed by a direction of the object and a normal of a reflection surface of the object, wherein
the reflection characteristic acquisition unit is configured to, when the light reception signal is saturated,
acquire the reflection characteristic using at least one of the pulse width or the falling slope, and
correct the reflection characteristic using the reflection surface angle.

6. The object detection apparatus according to claim 5, further comprising:
an object detection unit configured to detect the object, using the reflection characteristic and a distance to a reflection point of the emission light on the object.

7. The object detection apparatus according to claim 1, wherein
the falling slope is a rate of change over time of the light reception signal between a peak point, at which the light reception signal reaches a saturation intensity, and an end point, at which the light reception signal falls to the threshold.

8. The object detection apparatus according to claim 7, wherein
the falling slope detection unit is configured to
set a first threshold smaller than the saturation intensity and a second threshold smaller than the first threshold, and
calculate the falling slope, using a time until the light reception signal falls from the first threshold to the second threshold and a difference between the first threshold and the second threshold.

9. The object detection apparatus according to claim 7, wherein
the falling slope detection unit is configured to
set a third threshold smaller than the saturation intensity, and
calculate the falling slope, using a time until the light reception signal falls from a time when the light reception signal falls from the saturation intensity to the third threshold and a difference between the saturation intensity and the third threshold.

10. The object detection apparatus according to claim 1, wherein
the reflection characteristic acquisition unit is configured to acquire the reflection characteristic after averaging at least one of the pulse width or the falling slope.

11. The object detection apparatus according to claim 5, wherein
when the light reception signal is not saturated, the reflection characteristic acquisition unit is configured to acquire the reflection characteristic using at least one of an intensity or the pulse width of the light reception signal.

12. The object detection apparatus according to claim 1, wherein
when the light reception signal is not saturated, the reflection characteristic acquisition unit is configured to acquire the reflection characteristic using an intensity ratio of a difference between the intensity of the light reception signal and an intensity of background light to a difference between a saturation intensity of the light reception signal and the intensity of background light.

13. The object detection apparatus according to claim 3, wherein
the reflection characteristic acquisition unit is configured to switch, in a region where the light reception signal transitions between a non-saturated state and a saturated state, the reflection characteristic with a gradual change between the reflection characteristic in the non-saturated state and the reflection characteristic in the saturated state.

14. The object detection apparatus according to claim 1, wherein
the reflection characteristic acquisition unit is configured to acquire the reflection characteristic after averaging the intensity of the light reception signal.

15. The object detection apparatus according to claim 1, wherein
the reflection characteristic is one of the reflection intensity and the reflectance of the object.

16. The object detection apparatus according to claim 1, further comprising:
a background light correction unit configured to perform correction to remove an influence of background light from the light reception signal, wherein
the reflection characteristic acquisition unit is configured to acquire the reflection characteristic after the background light correction unit performs the correction to remove the influence of the background light from the light reception signal.

17. The object detection apparatus according to claim 16, wherein
the background light correction unit is configured to
remove, when the light reception signal is saturated, the influence of the background light on the pulse width and the falling slope, and
remove, when the light reception signal is not saturated, the influence of the background light on at least one of an intensity or the pulse width of the light reception signal.

18. The object detection apparatus according to claim 1, further comprising:
a reflection surface angle acquisition unit configured to acquire, as a reflection surface angle, an angle formed by a direction of the object and a normal of a reflection surface of the object, wherein
the reflection characteristic acquisition unit is configured to correct the reflection characteristic using the reflection surface angle.

19. The object detection apparatus according to claim 5, wherein
the reflection characteristic acquisition unit is configured to
perform, when the light reception signal is not saturated, correction to increase an intensity of the light reception signal as the reflection surface angle increases, and
perform, when the light reception signal is saturated, correction to decrease the intensity of the light reception signal as the reflection surface angle increases.

20. The object detection apparatus according to claim 5, wherein
the reflection surface angle acquisition unit is configured to acquire the reflection surface angle, using
at least one of a direction vector between two proximity points, which interpose a reflection point of the emission light on the object from above and below, or a direction vector between two proximity points, which interpose the reflection point on the object from left and right, and
a sensor vector indicating a direction from the reflection point to the light receiving unit.

21. The object detection apparatus according to claim 20, further comprising:
a thicket determination unit configured to determine whether the reflection point is in a thicket, using a distance from the light receiving unit to the reflection point and an adjacent reflection point in the vicinity of the reflection point and a variation in the reflection characteristic, wherein
when the reflection point is in the thicket, the reflection characteristic acquisition unit is configured to correct the reflection characteristic downward according to a variation in the distance from the light receiving unit to the reflection point and the adjacent reflection point.

22. The object detection apparatus according to claim 1, wherein
the reflection characteristic acquisition unit is configured to acquire the reflectance as a predetermined upper limit value in a condition where:
the distance to the object that reflects the emission light is equal to or less than a predetermined threshold;
the pulse detection unit detects a first pulse, which corresponds to the distance to the object that reflects the emission light, and a second pulse, which corresponds to twice the distance to the object that reflects the emission light;
a signal intensity of the first pulse is equal to or larger than a predetermined threshold; and
a signal intensity of the second pulse is equal to or larger than a predetermined threshold.

23. The object detection apparatus according to claim 1, further comprising:
a reflector detection unit configured to determine that the object at a position corresponding to the first light reception signal is a reflector, based on, at a predetermined position on the light receiving unit,
a first light reception signal, which corresponds to the distance to the object that reflects the emission light, and
a second light reception signal, which corresponds to a distance RL times the distance to the object obtained based on the first light reception signal, wherein the RL is an integer of 2 or more.

24. The object detection apparatus according to claim 1, further comprising:
a reduction unit configured to reduce at least one of an intensity of the reflected light or a detection sensitivity of the light reception signal corresponding to the reflected light; and
a reflector detection unit configured to
reduce at least one of the intensity of the reflected light or the detection sensitivity of the light reception signal corresponding to the reflected light, when the saturation determination unit determines that the light reception signal corresponding to the distance to the object that reflects the emission light is saturated, and
determine that the object at a position corresponding to the light reception signal is a reflector, when the light reception signal remains saturated even after the reduction.

25. An object detection apparatus configured to detect an object by reflected light from the object, the object detection apparatus comprising:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal;
a reflection characteristic acquisition unit configured to acquire a reflection characteristic including at least one of a reflection intensity or a reflectance of the object;
a reflection surface angle analysis unit configured to
analyze a position of the detected object or the light reception signal on the object for at least a part in a region where the object detection apparatus detects the object, and
analyze a reflection surface angle that is an angle formed by a direction of the object and a normal of a reflection surface of the object; and
a correction unit configured to correct, when the light reception signal is not saturated and when the analyzed reflection surface angle is larger than a predetermined angle threshold, at least one of the reflection intensity or the reflectance of the object in the reflection characteristic acquisition unit to a value larger than that when the reflection surface angle is equal to or less than the angle threshold, wherein
when the light reception signal is saturated, the reflection characteristic acquisition unit is configured to acquire the reflection characteristic using at least one of the pulse width or the falling slope.

26. The object detection apparatus according to claim 25, further comprising:
an object detection unit configured to detect the object, using the reflection characteristic and a distance to a reflection point of the emission light on the object.

27. An object detection apparatus configured to detect an object by reflected light from the object, the object detection apparatus comprising:
a light emitting unit configured to emit emission light toward a predetermined emission range;
a light receiving unit configured to receive reflected light corresponding to the emission light;
a distance calculation unit configured to calculate a distance to the object that reflects the emission light, using a time from emission of the emission light to reception of the reflected light;
a saturation determination unit configured to determine whether a light reception signal corresponding to the reflected light output from the light receiving unit is saturated;
a pulse detection unit configured to detect at least one of a pulse width of the light reception signal at a predetermined threshold or a falling slope of the light reception signal;
a falling slope detection unit configured to detect the falling slope of the light reception signal;
a reflection characteristic acquisition unit configured to acquire a reflection characteristic including at least one of a reflection intensity or a reflectance of the object; and
a reduction unit configured to reduce, when the saturation determination unit determines that the light reception signal corresponding to the distance to the object that reflects the emission light is saturated, at least one of an intensity of the reflected light or a detection sensitivity of the light reception signal corresponding to the reflected light to mitigate a saturation level of the light reception signal, wherein
the reduction unit is configured to
change the detection sensitivity of the light reception signal corresponding to the reflected light by switching the emission range in at least two stages, and
cause the reflection characteristic acquisition unit to acquire the reflection characteristic having a higher accuracy by the switching, and
when the light reception signal is saturated, the reflection characteristic acquisition unit is configured to acquire the reflection characteristic using at least one of the pulse width or the falling slope.

28. The object detection apparatus according to claim 27, further comprising:
an object detection unit configured to detect the object, using the reflection characteristic and a distance to a reflection point of the emission light on the object.
